(19) United States
(12) Patent Application Publication
(10) Pub. No.: US 2026/0025571 A1
(43) Pub. Date: Jan. 22, 2026

(54) IMAGE COMPOSITION WITH AUTOMATIC OBJECT IDENTIFICATION

(71) Applicant: QUALCOMM Incorporated, San Diego, CA (US)

(72) Inventors: Karthikeyan SHANMUGAVADIVELU, San Diego, CA (US); Viswesh PARAMESWARAN, San Diego, CA (US); Yifan WANG, San Diego, CA (US); Shizhong LIU, San Diego, CA (US); Hau HWANG, San Diego, CA (US)

(21) Appl. No.: 19/270,171

(22) Filed: Jul. 15, 2025

Related U.S. Application Data
(60) Provisional application No. 63/673,585, filed on Jul. 19, 2024.

(51) Int. Cl. H04N 23/60; H04N 23/611; H04N 23/63; H04N 23/661; H04N 23/80; H04N 23/81

(52) U.S. Cl. CPC H04N 23/64; H04N 23/611; H04N 23/632; H04N 23/661; H04N 23/80; H04N 23/81

(57) ABSTRACT

Systems and techniques are provided for processing image data. A first frame corresponding to first image data of a scene representing a plurality of objects can be output for display. Object information indicative of a subset of objects included in the plurality of objects can be determined. Second image data of the scene can be obtained including the plurality of objects. Edited image data can be generated based on the object information and the second image data, the edited image data including the subset of objects and not including at least one additional object of the plurality of objects. A second frame corresponding to the edited image data can be output for display including inpainted pixel data to replace respective captured pixel data corresponding to each additional object, the inpainted pixel data generated based on neighboring pixel data adjacent to the respective captured pixel data for each additional object.

### CROSS-REFERENCE TO RELATED APPLICATIONS

This application claims the benefit of U.S. Provisional Application No. 63/673,585, filed Jul. 19, 2024, which is hereby incorporated by reference, in its entirety and for all purposes.

### FIELD

The present disclosure generally relates to image processing. For example, aspects of the present disclosure are related to systems and techniques for performing image composition with automatic object identification, such as for subject selection or removal prior to image capture.

### BACKGROUND

Many devices and systems allow a scene to be captured by generating images (also referred to as frames or image frames) and/or video data (including multiple frames) of the scene. For example, a camera or a device including a camera can capture one or more images of a scene (e.g., a still image of the scene, one or more frames of a video of the scene, etc.). In some cases, the one or more images can be processed for performing one or more functions, can be output for display, can be output for processing and/or consumption by other devices, among other uses.

A common type of processing performed on images is image segmentation, which involves segmenting image and video frames into multiple portions. For example, image and video frames can be segmented into foreground and background portions. In some examples, semantic segmentation can segment image and video frames into one or more segmentation masks based on object classifications. For example, one or more pixels of the image and/or video frames can be segmented into classifications such as human, hair, skin, clothes, house, bicycle, bird, background, etc. The segmented image and video frames can then be used for various applications. Applications that use image segmentation are numerous, including, for example, computer vision systems, image augmentation and/or enhancement, image background replacement, extended reality (XR) systems, augmented reality (AR) systems, image segmentation, autonomous vehicle operation, among other applications.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for image processing. According to at least one illustrative example, a method of processing image data is provided. The method includes: outputting for display a first frame corresponding to first image data of a scene, the first image data representing a plurality of objects; determining object information indicative of a subset of one or more objects included in the plurality of objects; obtaining second image data of the scene, the second image data including the plurality of objects; generating edited image data based on the object information and the second image data, wherein the edited image data includes the subset of one or more objects and does not include at least one additional object of the plurality of objects; and outputting for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object.

In another illustrative example, an apparatus for processing image data is provided. The apparatus includes at least one memory and at least one processor coupled to the at least one memory and configured to: output for display a first frame corresponding to first image data of a scene, the first image data representing a plurality of objects; determine object information indicative of a subset of one or more objects included in the plurality of objects; obtain second image data of the scene, the second image data including the plurality of objects; generate edited image data based on the object information and the second image data, wherein the edited image data includes the subset of objects and does not include at least one additional object of the plurality of objects; and output for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object.

In another illustrative example, a non-transitory computer-readable storage medium comprising instructions stored thereon which, when executed by at least one processor, causes the at least one processor to: output for display a first frame corresponding to first image data of a scene, the first image data representing a plurality of objects; determine object information indicative of a subset of one or more objects included in the plurality of objects; obtain second image data of the scene, the second image data including the plurality of objects; generate edited image data based on the object information and the second image data, wherein the edited image data includes the subset of objects and does not include at least one additional object of the plurality of objects; and output for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object.

In another illustrative example, an apparatus is provided for processing image data. The apparatus includes: means for outputting for display a first frame corresponding to first image data of a scene, the first image data representing a plurality of objects; means for determining object information indicative of a subset of one or more objects included in the plurality of objects; means for obtaining second image data of the scene, the second image data including the plurality of objects; means for generating edited image data based on the object information and the second image data, wherein the edited image data includes the subset of one or more objects and does not include at least one additional object of the plurality of objects; and means for outputting for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1A is a block diagram illustrating an example architecture of an image capture and processing system, in accordance with some examples;

FIG. 1B illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 3A illustrates an example of an image frame including an object included in a subset of objects (e.g., a subject of interest) and an additional object (e.g., a subject of non-interest), in accordance with some examples;

FIG. 3B illustrates an example of the image frame of FIG. 3A with the additional object (e.g., subject of non-interest) removed, in accordance with some examples;

FIG. 4 is a diagram illustrating an example of an image processing engine configured to generate a first image output stream corresponding to an image preview frame with masking applied to one or more additional objects (e.g., subjects of non-interest), and configured to generate a second image output stream corresponding to a captured image frame with the one or more additional objects (e.g., subjects of non-interest) automatically removed, in accordance with some examples;

FIG. 5 is a diagram illustrating an example of face and torso detection associated with an image frame, in accordance with some examples;

FIG. 6 is a diagram illustrating an example of an image processing engine configured to generate a first image output stream indicative of predicted object information (e.g., subject differentiation information) for an input image frame, and a second image output stream corresponding to a captured image frame with object removal based on one or more inputs of object information, in accordance with some examples;

FIG. 7 is a flow diagram illustrating an example of a process for processing image and/or video data, in accordance with some examples; and

FIG. 8 is a block diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects of the application. However, it will be apparent that various aspects and examples may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras (e.g., image capture devices) can be provided in various forms and form factors, including dedicated or standalone cameras and other imaging systems, as well as smartphones, mobile computing devices, user computing devices, etc., where camera functionalities are combined with one or more additional functionalities in the same device. In some examples, mobile cameras or mobile camera devices can refer to image capture devices such as smartphones, mobile computing devices, user computing devices, etc. Some mobile camera devices may include multiple imaging sensors (e.g., multiple cameras), lenses, focal lengths, imaging systems, etc.

Mobile camera devices can include one or more displays for outputting (e.g., displaying) to a user of the mobile camera device one or more image preview frames of a scene or composition prior to performing image capture (e.g., obtaining a captured image frame using the mobile camera device). For example, the one or more image preview frames can be provided as a live preview that updates as the user changes the position and/or orientation of the mobile camera device, as the user changes one or more imaging parameters or camera settings of the mobile camera device, etc. The image preview frames can correspond to the imaged scene and/or composition that would be captured by the mobile camera device in response to receiving a user input to capture a frame. For example, the user input to capture a frame can correspond to a user input or user selection of a camera shutter or camera trigger, etc. The one or more image preview frames can be output by the mobile camera device prior to and/or without the mobile camera device receiving the user input to capture a frame. A captured image frame can be obtained by the mobile camera device in response to receiving the user input to the capture the frame.

As used herein, an “image frame” can refer to a frame of image data captured corresponding to a still photograph, and/or can refer to a frame of image data that captured as one frame of video included in a plurality of frames of video. For example, an “image frame” can be a standalone still photograph and/or can be a video frame that is included in a plurality of video frames corresponding to a video capture. An image preview frame can be a preview of the captured image frame that would be obtained using the current camera settings and current camera position and orientation. In some aspects, an image preview frame can be an preview frame corresponding to a photograph and/or can be a preview frame corresponding to a video (e.g., a video preview frame included in a plurality of video preview frames, such as a time-ordered sequence of video preview frames). In some cases, the image preview frame can be a lower-quality or reduced-quality image relative to a captured image frame. For example, image preview frames can be obtained with lower relative image quality to provide a real-time update or refresh rate to the image preview output displayed in a viewfinder or user interface of the mobile camera device. Image preview frames may also be obtained with lower relative image quality to reduce the power consumption of the mobile camera device (e.g., based on the higher relative image quality associated with captured imaged frames corresponding to a higher power consumption by the mobile camera device).

As used herein, a preview of an image can also be referred to as a “preview frame” and/or a “captured image preview frame.” In some aspects, a captured image may correspond to a preview frame that was generated earlier in time or concurrently with generating (e.g., capturing) the captured image frame. In one example, a first preview frame can be captured and/or outputted prior to receiving an input to capture a frame. The input to capture a frame can be received subsequent to capturing and/or outputting the first preview frame. A captured frame can be captured and/or outputted based on the input to capture a frame, where the captured frame is subsequent to the first preview frame and the input to capture a frame. In some cases, the first preview frame is a real-time image preview frame corresponding to an image composition of a scene, and the captured frame is a captured image frame corresponding to the same image composition of the scene and/or corresponding to the real-time image preview frame.

In some cases, image preview data can be live preview data associated and/or generated by a camera and/or image capture device, etc. As noted above, the live preview data can comprise live preview data corresponding to a photographic image and/or can comprise live preview data corresponding to a sequence of a plurality of video frames for a video capture. In some cases, an image preview or an image preview data can also be referred to as a live image preview or a live image preview data, respectively. In some examples, live image preview data can be obtained prior to an image capture input and/or receiving a command to capture an image (e.g., selection of an image capture user interface (UI) and/or graphical user interface (GUI) element, activation of an image capture trigger, etc.). For example, image preview data can correspond to a first frame that is output prior to receiving an input to capture a frame. In some cases, live image preview data can be outputted using a display of an image capture device and utilized by a user (e.g., of the image capture device) to review and/or compose the image prior to capturing the image. For example, live image preview data can be provided on a display of an image capture device while trying to capture a scene. In some examples, the live image preview data can be obtained after raw sensor data (e.g., collected by the image capturing device's sensors) has undergone various pre-processing stages such as demosaicing, denoising, etc. In some cases, a stream of live image preview frames provided on a display of the image capture device can be associated with a subsequent capture operation based on an input from a user of the image capture device, where the subsequent capture operation causes the image capture device to capture an image based on the stream of live preview frames and/or where the subsequent capture operation causes the image capture device to capture a plurality of video frames (e.g., video data, sequence of video frames, etc.) based on the stream of live preview frames. In some examples, a shared or common image preview processing pipeline can be associated with capturing and outputting preview frames prior to capturing an image or capturing video by the image capture device. In some cases, a first image preview processing pipeline can be associated with capturing and outputting preview frames prior to capturing an image by the image capture device, and a second image preview processing pipeline can be associated with capturing and outputting preview frames prior to capturing a video by the image capture device.

In some examples, image data can be obtained from an image sensor of a mobile camera device and may be processed using a first image processing pipeline configured to generate as output a first stream of image data. The first image processing pipeline can be a live and/or real-time image preview image processing pipeline, and the first stream of image data can be image preview data comprising a plurality of image preview frames. Image data can be obtained from the same image sensor of the mobile camera device, and may be processed using a second image processing pipeline configured to generate as output a second stream of image data. The second image processing pipeline can be an image capture image processing pipeline, and the second stream of image data can be image capture data corresponding to one or more captured image frames. In some cases, the image data obtained from the image sensor of the mobile camera device and used to generate the first stream of image preview frames can be the same as the image data obtained from the image sensor and used to generate the second stream of image capture frames. In some examples, the image data obtained from the image sensor and used to generate the first stream of image preview frames can be different from the image data obtained from the image sensor and used to generate the second stream of image capture frames.

As noted above, image preview frames and/or image preview data may be used to determine and/or adjust the composition of a scene that is being captured by a mobile camera device, prior to or concurrent with the user providing an input to trigger the mobile camera device to capture an image frame of the scene and using the currently configured composition. Portrait image capture is a popular use case for mobile camera devices, and can correspond to capturing one or more images with at least one human subject within the frame. In some cases, the imaged scene that is being captured by the mobile camera device (e.g., captured in one or more image preview frames and/or one or more image capture frames) can include multiple different subjects and/or objects. As used herein, the term “object” may refer to a human subject, an object, an entity, etc., captured within a frame of image data. For example, an “object” can be a “subject”, and vice versa. As used herein, the terms “object” and “subject” may be used interchangeably. In some aspects, a frame of image data can include a plurality of objects (e.g., subjects). One or more “subjects of interest” can refer to a subset of one or more objects included in the plurality of objects. As used herein, “subjects of interest” may be used interchangeably with a “subset of objects” or a “subset of a plurality of objects.” One or more “subjects of non-interest” can refer to at least one additional object of the plurality of objects. For example, the at least one additional object is not included in the subset of objects corresponding to the one or more subjects of interest. As used herein, “subjects of non-interest” can be used interchangeably with “additional objects” or “at least one additional object.” In some cases, “subject differentiation information” can refer to information indicative of a classification of an object (e.g., subject) as a subject of interest (e.g., included within the subset of objects) or as a subject of non-interest (e.g., not included within the subset of objects, included within the at least one additional object). As used herein, the terms “subject differentiation information” and “object information” may be used interchangeably.

A first subset or first portion of the subjects and objects in the frame composition (e.g., camera view of the scene) may be of interest to the photographer, and are intended to be included in the frame composition. A second subset or second portion of the subjects and objects in the frame composition may not be of interest to the photographer, and may not be intended for inclusion in the frame composition. Humans, objects, etc., that are within the frame composition or camera view of the scene, but are not intended subjects of the photographer (e.g., user of the mobile camera device) can be referred to as unintended subjects, non-intended subjects, subjects of non-interest, etc. Humans, objects, etc., that are within the frame composition or camera view of the scene, and are intended subjects of the photographer can be referred to as subjects of interest, etc.

In some cases, a user of a mobile camera device may attempt to obtain or adjust an image composition (e.g., of a preview frame, a captured frame, or both) to include the subjects and objects that are of interest, while excluding the subjects and objects that are not of interest. It is not always possible or feasible for the photographer (e.g., user of the mobile camera device) to find an image composition that includes only the desired or intended subjects, while excluding all undesired or unintended subjects. For example, distracting subjects or objects may suddenly appear within the frame of the image composition during the time delay between the user finalizing the composition while viewing the stream of image preview frames, and the user then providing the input to subsequently cause the mobile camera device to obtain a captured image frame of the same scene or image composition. In another example, unwanted subjects may appear in the frame or image composition of the scene when the user takes photographs in public places or otherwise takes photographs of scenes that include humans, objects, subjects, etc., that either cannot be moved out of frame or that are beyond the user's control to move out of the frame of the image composition.

There is a need for systems and techniques that can be used to provide image composition with automatic object (e.g., subject) identification for object (e.g., subject) selection and/or object (e.g., subject) removal from the subsequent preview frames and/or captured frames corresponding to the same image composition. There is a further need for systems and techniques that can be used to provide image composition to include subjects of interest and remove unwanted subjects (e.g., subjects of non-interest) during the capture and/or generation of image preview frames, during the capture and/or generation of captured image frames, and/or during the capture and/or generation of both image preview frames and captured image frames corresponding to preview frames.

Systems, apparatuses, processes (also referred to as methods), and computer-readable media (collectively referred to as “systems and techniques”) are described herein that can be used to provide image composition with automatic object (e.g., subject) identification and/or classification for object (e.g., subject) selection or removal prior to image capture. For example, the systems and techniques can be used to generate captured image frames with one or more unwanted subjects (e.g., additional objects) removed, where the unwanted subject(s) is/are removed prior to image capture. In some aspects, the systems and techniques can be implemented by an imaging system of a computing device (e.g., a mobile camera device, an XR device such as a virtual reality (VR) device, an augmented reality (AR) device, or a mixed reality (MR) device, or other device) to automatically generate one or more streams of image data corresponding to a configured image composition with unwanted subject removal. For example, the imaging system can generate a first stream of image data comprising one or more preview frames corresponding to the image composition with unwanted subject removal, and can generate a second stream of image data comprising one or more captured image frames corresponding to the image composition with unwanted subject removal.

In some examples, a first stream of image data can be generated corresponding to one or more preview frames for an image composition of or within a scene (e.g., a scene that is being photographed by a user of the mobile camera device, etc.). One or more machine learning networks can be configured to identify respective subjects within the composed frame. For example, the identified subjects can include humans, objects, etc., that appear within the one or more preview frames captured and generated by the mobile camera device. In some aspects, the subject identification can be performed based on using one or more segmentation machine learning networks to determine segmentation results or segmentation information for one or more of the preview frames. For example, the segmentation information can include one or more segmentation masks generated to indicate one or more locations, areas, and/or pixels within a frame of image data that belong to a given semantic segment (e.g., a particular object, class of objects, etc.). For instance, each pixel of a segmentation mask can include a value indicating a particular semantic segment (e.g., a particular object, class of objects, etc.) to which each pixel belongs.

In some examples, features can be extracted from an image frame and used to generate one or more segmentation masks for the image frame based on the extracted features. In some cases, machine learning can be used to generate segmentation masks based on the extracted features. For example, a convolutional neural network (CNN) can be trained to perform semantic image segmentation by inputting into the CNN many training images and providing a known output (or label) for each training image. The known output for each training image can include a ground-truth segmentation mask corresponding to a given training image. In some cases, image segmentation can be performed to segment image frames into segmentation masks based on an object classification scheme (e.g., the pixels of a given semantic segment all belong to the same classification or class). For example, one or more pixels of an image frame can be segmented into classifications such as human, hair, skin, clothes, house, bicycle, bird, background, etc. In some examples, a segmentation mask can include a first value for pixels that belong to a first classification, a second value for pixels that belong to a second classification, etc. A segmentation mask can also include one or more classifications for a given pixel. For example, a “human” classification can have sub-classifications such as ‘hair,’ ‘face,’ or ‘skin,’ such that a group of pixels can be included in a first semantic segment with a ‘face’ classification and can also be included in a second semantic segment with a ‘human’ classification.

In some cases, the systems and techniques can determine and/or identify the respective subjects within the frame of the image composition (e.g., within one or more preview frames captured by the mobile camera device) based on segmentation information generated by analyzing the one or more preview frames using a segmentation machine learning network. In some examples, the systems and techniques can utilize one or more additional machine learning networks and/or subject detection or identification techniques. For example, the image composition scene within a stream of image preview data can be continuously or periodically analyzed to perform one or more of image semantic segmentation, face detection, torso detection, depth estimation, pose estimation, gaze estimation, etc. In some aspects, the systems and techniques can generate and update an instance map to correlate and track respective subjects across the multiple preview frames that are generated by the mobile camera device. For example, a human subject can be identified in a first preview frame based on segmentation information, face detection information, torso detection information, depth information, pose information, gaze information, etc. The human subject identified or determined within the first preview frame can be associated to a particular location within the first preview frame.

The human subject identified or determined within the first preview frame can be mapped to a corresponding subject instance or subject identifier in the instance map information. For one or more subsequent preview frames (e.g., a second preview frame, third preview frame, . . . , etc., captured after the first preview frame), respective subject identification information determined for the subsequent frame can be compared to, analyzed against, and/or otherwise correlated with the existing subject instance information within the instance map.

Based on the identification and/or instance information determined for the respective subjects within the stream of image data corresponding to the preview frames captured by the mobile camera device, the systems and techniques can be used to generate and/or configure an adjusted or edited composition to remove one or more unwanted subjects from the imaged scene, prior to the capture of an image frame (e.g., a captured frame corresponding to or based on the one or more preview frames). For example, one or more user inputs can be received and used to determine the one or more unwanted subjects to remove from the image frame.

In some cases, the one or more user inputs can be received for a first preview frame, and can be used to generate an updated scene composition for one or more subsequent preview frames that are captured and output for display after the first preview frame. In some cases, the one or more user inputs can be received as touch inputs to a display of the mobile camera device used to display the first preview frame. In some examples, the one or more user inputs can be received as a selection of one or more of the identified subjects based on a touch input to the display and/or graphical user interface (GUI) of the mobile camera device. For example, the scene composition can be edited based on a user input to select the one or more unwanted subjects to be removed from the composition. In some examples, the scene composition can be edited based on a user input to select one or more wanted subjects (e.g., subjects of interest) that are to be kept in the edited or updated composition. The remaining subjects that were previously identified based on the analysis of the preview frame, but not selected or indicated by the one or more user inputs, can be determined to be unwanted subjects and can be removed from the edited or updated composition.

In some cases, the edited or updated composition can be output for display as one or more subsequent preview frames that are edited to provide an indication of the subjects that will be removed in the final composition of the resulting captured image frame. For example, after determining the unwanted subjects for removal in the final (e.g., edited or updated) composition, subsequent image preview frames can apply masking or other visual changes to the unwanted subjects that will be removed in the final captured image composition. In some cases, after determining the unwanted subjects for removal in the final captured image frame composition, subsequent image preview frames (e.g., generated and output for display prior to receiving a user input to capture the final captured image frame) can be generated to automatically remove the unwanted subjects.

The unwanted subjects can be removed based on segmentation information and/or other instance identification information (e.g., determined based on the face detection information and/or corresponding detected facial features, torso detection information and/or corresponding detected torso features, depth estimation information, pose estimation information, gaze estimation information, etc.) indicative of the pixels or pixel locations that correspond to each respective unwanted subject that is to be removed. Inpainting can be performed to replace the pixels corresponding to unwanted subjects with generated pixels determined based on contextual information of neighboring pixels and/or neighboring portions of the imaged scene. For example, the neighboring pixels and/or neighboring portions of the imaged scene can comprise neighboring captured pixel data that is adjacent to the respective captured pixel data corresponding to each additional object (e.g., unwanted subject that is to be removed, etc.).

In some examples, the inpainting can be performed using one or more inpainting machine learning networks provided on the mobile camera device. For example, the mobile camera device can include an image completion and inpainting engine that is configured to generate inpainted image regions to replace the pixels that are deleted or removed during the removal of unwanted subjects within the composed image frame. For example, an inpainting machine learning network and/or the image completion and inpainting engine of the mobile camera device can be used to generate image data for the missing portion(s) of the image frame that correspond to the removed, unwanted subject(s). The inpainting machine learning network and/or the image completion and inpainting engine can be used to generate image data for the missing portion(s) within the image frame, by generating new pixel data to fill the negative space corresponding to the removed, unwanted subject(s). The generated pixel data from the inpainting machine learning network and/or the image completion and inpainting engine can be generated based on analyzing pixel information, semantic information, etc., of neighboring pixels (e.g., adjacent captured pixel data of the intended and/or desired subjects, etc.) that were not removed from the image frame, and/or based on analyzing pixel information, semantic information, etc., of non-removed background portions of the image frame.

In some cases, the systems and techniques can analyze one or more previously captured image preview frames to determine predicted subject classification information, where the predicted subject classification information is indicative of a prediction or suggestion of one or more subjects for removal. The prediction or suggestion of the one or more subjects for removal can be based on determining respective subjects that are identified within the composed image frame of the scene, and which are further identified as being unwanted subjects and/or are not identified as being subjects of interest. In some cases, the systems and techniques can generate and/or determine auto-suggestion information indicative of an automatically determined identification of the subjects of interest that are to be kept in an updated image composition and the unwanted subjects (e.g., subjects of non-interest) that are to be deleted (e.g., removed) in the updated image composition.

In some cases, one or more initial image preview frames can be analyzed and used to determine the predicted subjects of interest and/or the predicted subjects of non-interest, where each respective subject of a plurality of identified subjects determined for the initial image preview frames is predicted (e.g., classified) as either a subject of interest or a subject of non-interest. In some aspects, for one or more subsequent image preview frames, the predicted subject differentiation information (e.g., object information) can be used to automatically differentiate subjects of interest from the background and/or from other incidental subjects (e.g., subjects of non-interest). In some examples, a user input to capture an image frame that is received after outputting one or more image preview frames with the automatic differentiation information indicating the subjects of non-interest to be removed, can cause the mobile camera device to capture the image frame using an updated composition that removes the automatically differentiated subjects of non-interest. For example, capturing an image frame without modifying or rejecting the auto-suggestion information corresponding to the differentiation between subjects of interest and subjects of non-interest can be interpreted as a user input indicative of the user accepting the suggested subject differentiation information (e.g., object information).

Various aspects of the present disclosure will be described with respect to the figures.

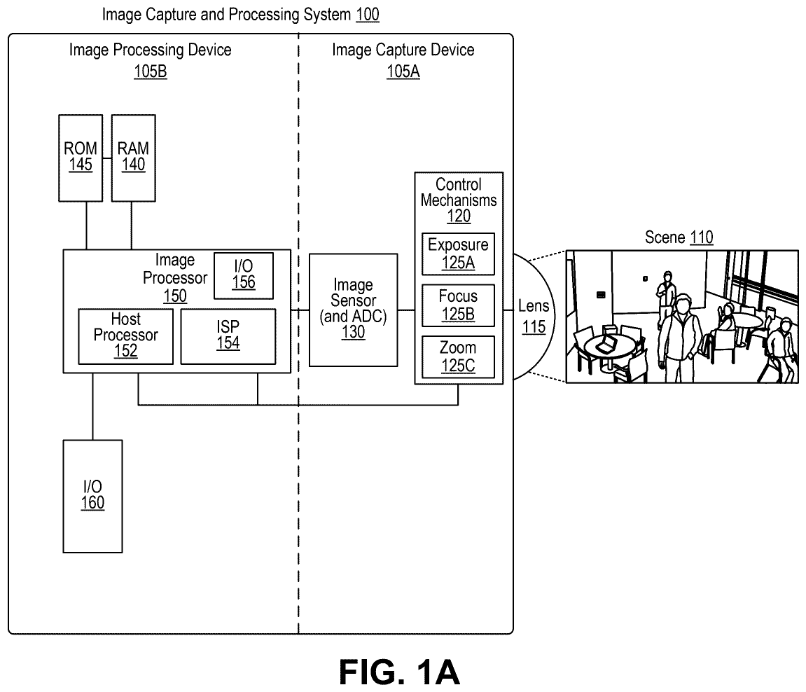

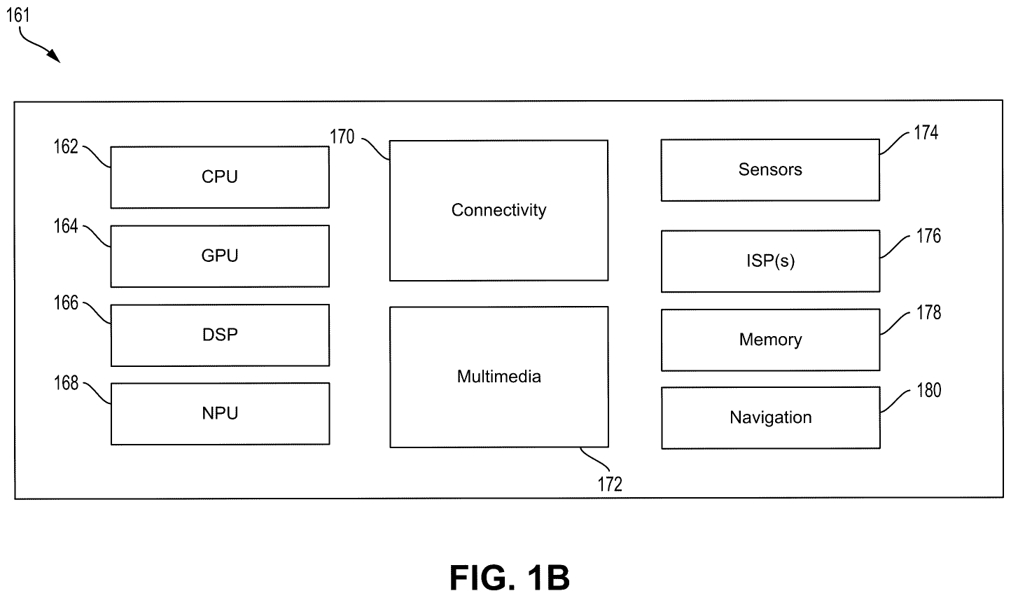

FIG. 1A is a block diagram illustrating an architecture of an image capture and processing system 100 (which can also be referred to as an imaging system). The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 810 discussed with respect to the computing device architecture 800. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (13C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

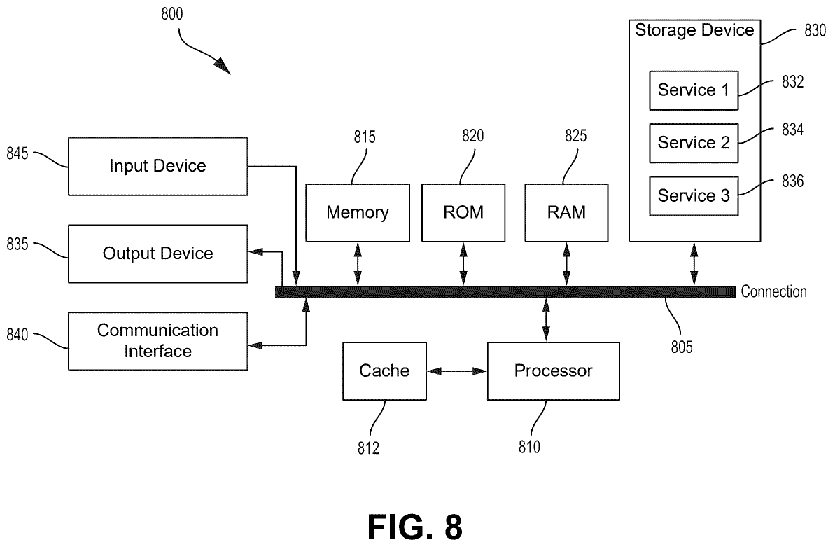

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/825 (of FIG. 8), read-only memory (ROM) 145/820, a cache 812, a memory unit (e.g., system memory 815), another storage device 830, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 835 of FIG. 8, any other input devices 845, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the system 100 and one or more peripheral devices, over which the system 100 may receive data from the one or more peripheral device and/or transmit data to the one or more peripheral devices. The I/O devices 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1A, a vertical dashed line divides the image capture and processing system 100 of FIG. 1A into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1A. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens (or sensor) noise correction, de-mosaicing, color conversion, correction or enhancement/suppression of image attributes, denoising filters, sharpening filters, among others. Each module of the ISP 154 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

FIG. 1B illustrates an example implementation of a system-on-a-chip (SOC) 161, which may include a central processing unit (CPU) 162 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 168, in a memory block associated with a CPU 162, in a memory block associated with a graphics processing unit (GPU) 164, in a memory block associated with a digital signal processor (DSP) 166, in a memory block 178, and/or may be distributed across multiple blocks. Instructions executed at the CPU 162 may be loaded from a program memory associated with the CPU 162 or may be loaded from a memory block 178.

The SOC 161 may also include additional processing blocks tailored to specific functions, such as a GPU 164, a DSP 166, a connectivity block 170, which may include fifth generation (5G) connectivity, fourth generation long term evolution (4G LTE) connectivity, Wi-Fi connectivity, USB connectivity, Bluetooth connectivity, and the like, and a multimedia processor 172 that may, for example, detect and recognize gestures. In one implementation, the NPU is implemented in the CPU 162, DSP 166, and/or GPU 164. The SOC 161 may also include a sensor processor 174, image signal processors (ISPs) 176, and/or navigation module 180, which may include a global positioning system.

The SOC 161 may be based on an ARM instruction set. In an aspect of the present disclosure, the instructions loaded into the CPU 162 may comprise code to search for a stored multiplication result in a lookup table (LUT) corresponding to a multiplication product of an input value and a filter weight. The instructions loaded into the CPU 162 may also comprise code to disable a multiplier during a multiplication operation of the multiplication product when a lookup table hit of the multiplication product is detected. In addition, the instructions loaded into the CPU 162 may comprise code to store a computed multiplication product of the input value and the filter weight when a lookup table miss of the multiplication product is detected.

SOC 161 and/or components thereof may be configured to perform image processing using machine learning techniques according to aspects of the present disclosure discussed herein. For example, SOC 161 and/or components thereof may be configured to perform semantic image segmentation according to aspects of the present disclosure. In some cases, by using neural network architectures such as transformers and/or shifted window transformers in determining one or more segmentation masks, aspects of the present disclosure can increase the accuracy and efficiency of semantic image segmentation.

In general, machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IOT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

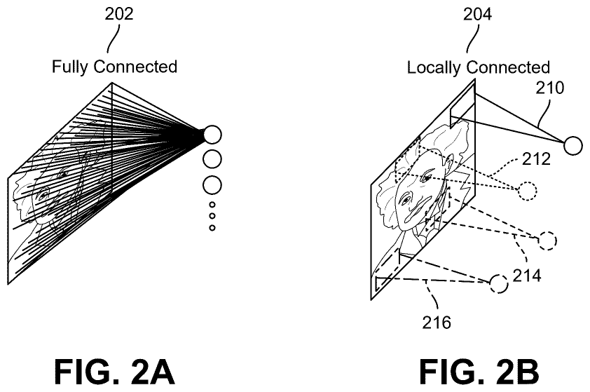

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, as the higher layer neurons in a given region may receive inputs that are tuned through training to the properties of a restricted portion of the total input to the network.

As noted previously, the systems and techniques described herein can be used to provide image composition with automatic subject identification and/or classification that can be used to generate captured image frames (e.g., still images of the scene, one or more frames of a video of the scene, etc.) with unwanted subjects removed. In some aspects, the systems and techniques can be implemented by a mobile camera device to automatically generate one or more streams of image data (e.g., still image frames and/or video frames) corresponding to a configured image composition with unwanted subject removal. For example, the mobile camera device can generate a first stream of image data comprising one or more preview frames corresponding to the image composition with unwanted subject removal, and can generate a second stream of image data comprising one or more captured image frames corresponding to the image composition with unwanted subject removal.

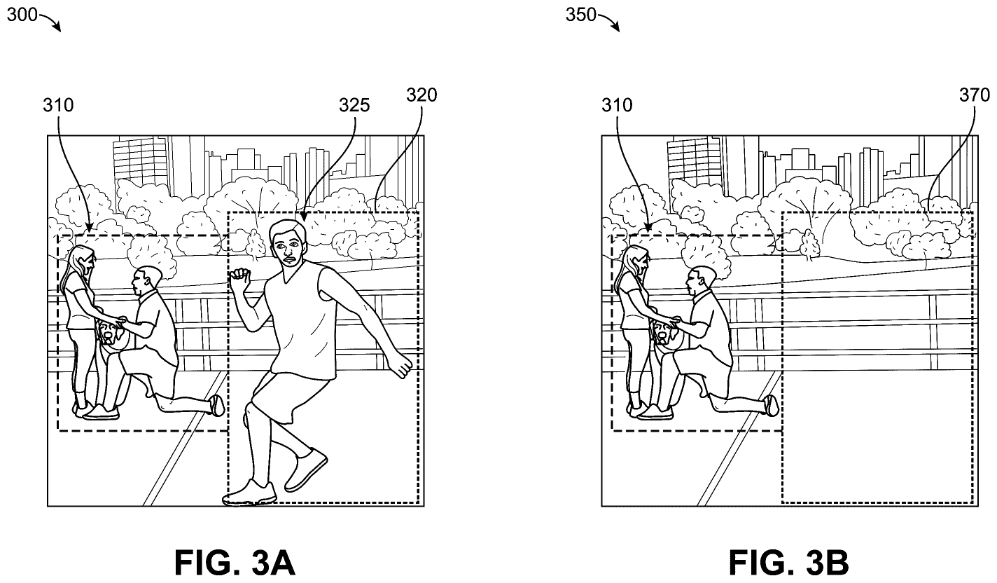

For example, FIG. 3A illustrates an example image frame 300 including a subject of interest 310 (e.g., an object included in a subset of objects, such as a subset of the plurality of objects within the example image frame 300) and a subject of non-interest (e.g., an unwanted subject) 325 (e.g., an additional object included in the plurality of objects and not included in the subset of objects), in accordance with some examples. FIG. 3B illustrates an example image frame 350 including the subject of interest 310 (e.g., object included in the subset of objects) and with the subject of non-interest (e.g., additional object) of FIG. 3A removed. As noted above, an image frame may be a still image frame and/or a video frame included in a plurality of video frames. For example, the image frame 300 can be a still image frame and/or can be a video frame included in a plurality of video frames (e.g., included in a sequence of the plurality of video frames).

In one illustrative example, the example image frame 350 of FIG. 3B can be generated based on the original image frame 300 of FIG. 3A, for example based on removing the unwanted subject 325 from the region 320 within the original image frame 300 of FIG. 3A. In some aspects, the unwanted subject region 320 in the original image frame 300 of FIG. 3A can be the same as the region 370 in the edited image frame 350 of FIG. 3B. For example, the region 370 in the edited image frame 350 of FIG. 3B can also be referred to as an “inpainted region” 370, and can be generated based on performing inpainting and/or image completion to generate new image pixel data to replace a set of removed pixels corresponding to the unwanted subject 325 within the unwanted subject region 320 of the original image frame 300 of FIG. 3A.

In some aspects, the example image frame 300 of FIG. 3A can be referred to as a “first” image frame, an “original” image frame, and/or an “input” image frame. The example image frame 350 of FIG. 3B can be referred to as a “second” image frame, an “edited” or “adjusted” image frame, and/or an “output” image frame. In some aspects, the image frame 300 of FIG. 3A and/or the image frame 350 of FIG. 3B may be preview frames that are captured and output for display prior to receiving a user input to capture an image frame. In some aspects, the image frame 300 of FIG. 3A and/or the image frame 350 of FIG. 3B may be captured image frames that are captured based on receiving a user input to capture an image frame. In some examples, the image frame 300 of FIG. 3A can be a preview frame, and the image frame 350 of FIG. 3B can be a captured image frame.

The first image frame 300 can include one or more subjects of interest that are intended for inclusion in the photographic composition by the photographer (e.g., user of a mobile camera device used to capture and/or generate the image frame 300 and/or image frame 350, etc.). For example, the first image frame 300 can include the subjects of interest 310. Subjects of interest can be located in the foreground of the photographic composition (e.g., also referred to as an image scene, imaged scene, frame composition, etc.), can be located in the background of the photographic composition, can be located between the foreground and background of the photographic composition, etc. For example, the subjects of interest 310 of FIGS. 3A and 3B are, in this example, associated with the background or midground of the photographic composition in image frame 300 and image frame 350, respectively.

As used herein, a subject of interest may refer to a singular human, object, entity, etc., within the photographic composition or frame, and/or may refer to multiple (e.g., a set or group) of humans, objects, entities, etc., within the photographic composition or frame. For example, the subjects of interest 310 of FIGS. 3A and 3B (e.g., two humans and a dog) can be treated as three separate but related subjects of interest (e.g., a first subject of interest as the standing human, a second subject of interest as the kneeling human, a third subject of interest as the dog, etc.). The subjects of interest 310 of FIGS. 3A and 3B may also be treated as a single subject of interest comprising multiple discrete but related entities (e.g., the two humans and the dog).

The first image frame 300 can additionally include one or more subjects that are not of interest (e.g., also referred to as “unwanted”, “undesired”, “spurious”, and/or “incidental”, etc., subjects). For example, the first image frame 300 can include an unwanted subject 325 and/or an unwanted subject region 320. An unwanted subject (e.g., subject of non-interest) can be a subject (e.g., object, entity, human, animal, etc.) that is currently within the imaged frame, but is not intended or desired to be included in the composition. For example, the unwanted subject 325 may be a distracting subject or object that has temporarily moved or appeared within the frame of the photographic composition. In one illustrative example, differentiation between a subject of interest (e.g., subjects of interest 310) and a subject of non-interest (e.g., unwanted subject 325) can be based on an intended or desired composition for the image frame of the scene (e.g., based on or associated with the photographer or user of a mobile camera device that composes and captures the image frame 300 and 350, etc.).

In some cases, a user of a mobile camera device may attempt to obtain or adjust an image composition (e.g., of a preview frame, a captured frame, or both) to include the subjects and objects that are of interest (e.g., subjects of interest 310), while excluding the subjects and objects that are not of interest (e.g., unwanted subject 325). In some cases, it may not always be possible or feasible for the photographer (e.g., user of the mobile camera device) to find an image composition that includes only the desired or intended subjects of interest 310, while excluding all undesired or unintended subjects 325. For example, distracting subjects or objects may suddenly appear within the frame of the image composition during the time delay between the user finalizing the composition while viewing the stream of image preview frames, and the user then providing the input to subsequently cause the mobile camera device to obtain a captured image frame of the same scene or image composition. In another example, unwanted subjects may appear in the frame or image composition of the scene when the user takes photographs in public places or otherwise takes photographs of scenes that include humans, objects, subjects, etc., that either cannot be moved out of frame or that are beyond the user's control to move out of the frame of the image composition.

In one illustrative example, the systems and techniques can be used to provide image composition with automatic subject identification of the respective subjects within one or more frames of image data. For example, the systems and techniques can analyze one or more frames of image data (e.g., such as the first image frame 300, which can be a preview frame) to identify one or more subjects that are present within the frame or photographic composition of the scene being imaged. Based on the identified subjects within the image frame of the photographic composition, subject differentiation information (e.g., object information) can be determined and/or obtained, indicative of a classification of each respective identified subject as a subject of interest (e.g., a subject to be included in the photographic composition of the image frame) or as a subject of non-interest (e.g., an unwanted subject that should be not included and/or may be removed from the photographic composition of the image frame). Based on the subject differentiation information and the subject identification information, an edited or output image frame can be generated that includes pixel or image data corresponding to the subjects of interest and that does not include (e.g., removes, replaces, etc.) pixel or image data corresponding to the unwanted subjects of non-interest.

For example, the first image frame 300 can be analyzed to identify the respective subjects included in the photographic composition of the scene (e.g., standing human, dog, kneeling human, running human). Each respective subject of the set of identified subjects determined for the first image frame can subsequently be associated with respective subject differentiation information (e.g., object information), indicating whether each identified subject is a subject of interest that will be included in the edited or output image frame 350, or is a subject of non-interest that will be removed (e.g., not included) in the edited or output image frame 350. For example, the subject differentiation information determined for the subjects within the first image frame 300 can indicate or classify the standing human, kneeling human, and dog as the subject(s) of interest 310, and can indicate or classify the running human in the foreground as the unwanted subject (e.g., subject of non-interest) 325.

In some aspects, the subject identification information can be determined using one or more machine learning networks and/or based on segmentation information (e.g., segmentation map, etc.) corresponding to the input image frame 300. In some cases, the segmentation information (e.g., segmentation map, etc.) can be generated by an image segmentation (e.g., image semantic segmentation) machine learning network.

In some examples, the subject differentiation information (e.g., object information) can be determined based on predicted subject classification information determined by one or more machine learning networks. In some cases, the subject differentiation information can be determined based on one or more user inputs indicative of a selection and/or identification of one or more subjects within the image frame as subjects of interest or subjects of non-interest. In one illustrative example, the subject differentiation information can be determined based on a combination of predicted subject classification information determined by one or more machine learning networks, and one or more subsequent user inputs indicative of an acceptance (e.g., confirmation) or an edit to one or more of the predicted subject classifications associated with the initial, machine learning-based subject differentiation.

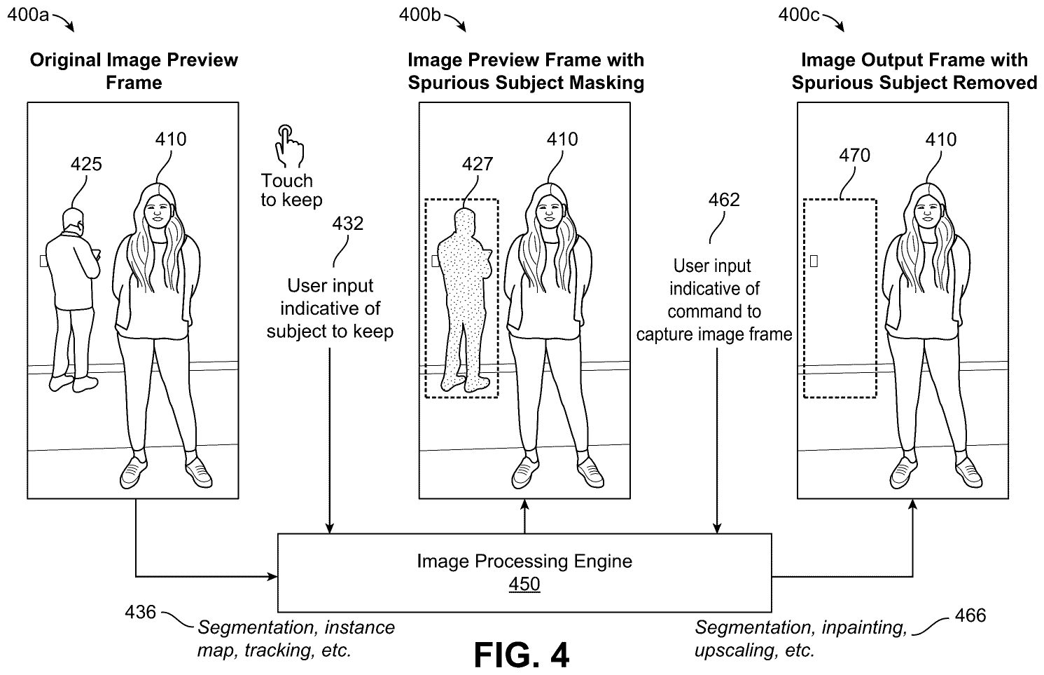

For example, FIG. 4 is a diagram illustrating an example of an image processing system that includes an image processing engine 450 configured to output for display a first image data or stream of image data corresponding to preview frames, and configured to output for display a second image data or stream of image data corresponding to one or more captured image frames. In one illustrative example, the image processing engine 450 can be associated with a first image preview frame 400a (e.g., which may be an original or unedited preview frame), a second image preview frame 400b (e.g., which may an edited version of the original preview frame, or an edited version of a subsequent preview frame with the edits based on the original preview frame), and a third image frame 400c (e.g., which may be an edited version of a captured image frame, with the edits based on the edited version of the original preview frame and/or one or more user inputs associated with the edited version of the original preview frame). In some aspects, the first image frame 400a can also be referred to as a first image preview frame 400a. In some aspects, the second image frame 400b may also be referred to as a second image preview frame 400b, an edited image preview frame 400b, and/or a masked image preview frame 400b. In some aspects, the third image frame 400c may also be referred to as an edited image frame 400c and/or a captured image frame 400c, among various others.

In some aspects, the third image frame 400c (e.g., the edited version of the captured image frame) can be edited to remove unwanted or spurious subjects, also referred to herein as “additional objects” or “at least one additional object” (e.g., subjects of non-interest, such as the unwanted subject 325 of FIG. 3A) during the image capture processing. For example, the unwanted subject 425 of FIG. 4 (e.g., which may be the same as or similar to the unwanted subject 325 of FIGS. 3A and 3B) can be automatically removed during the image capture processing pipeline associated with capturing and generating for output the third image frame 400c. In one illustrative example, the unwanted subject 425 is automatically removed and inpainted pixels are generated within a corresponding inpainted region 470 prior to outputting the third image frame 400c for display. For example, the unwanted subject 425 is automatically removed and image completion and/or inpainting are performed to generate the pixel data of the inpainted region 470 during the image capture pipeline processing that is associated with capturing the third image frame 400c. The unwanted subject 425 may be removed and replaced with the generated pixels of the inpainted region 470 prior to the edited image frame 400c being output for display and prior to the edited image frame 400c being stored or saved in memory (e.g., the unwanted subject 425 can be removed and replaced with the generated pixels of the inpainted region 470 prior to the final processing step or output of the image capture and post-processing pipeline implemented by the mobile camera device, etc.).

In some aspects, the first image frame 400a and the second image preview frame 400b can be image preview frames, captured and output for display by a mobile camera device prior to the mobile camera device generating a captured image frame (e.g., prior to the mobile camera device receiving a user input to capture an image). In some examples, the first image frame 400a and the second image preview frame 400b can be image preview frames that are included within or associated with the first stream of image data output for display by the mobile camera device. The first stream of image data can be a stream of image preview frames (e.g., including live and/or real-time streams of image preview frames, etc.). The third image frame can be a captured image frame, as noted above, and can be include within or associated with the second stream of image data output for display by the mobile camera device. The second stream of image data can be one or more captured image frames.

The first image frame 400a can also be referred to as an original or input image frame (e.g., an unedited or non-masked image preview frame). For example, the first image frame 400a can be an original (e.g., unedited, etc.) image preview frame the same as or similar to the original or unedited image preview frame 300 of FIG. 3A.

The first (e.g., unedited) image preview frame 400a can be output for display by the mobile camera device, and can be analyzed by the image processing engine 450 to determine subject identification information indicative of the respective subjects that are included within the photographic composition of the first image preview frame 400a. For example, the image processing engine 450 can analyze the first image preview frame 400a to determine respective subject identification information indicative of a first subject (e.g., subject of interest 410) and a second subject (e.g., unwanted subject 425).

In some aspects, the image processing engine 450 can include one or more machine learning networks configured to identify the respective subjects within an image frame received as input to the image processing engine 450. For example, the image processing engine 450 can include and utilize one or more machine learning networks to identify the first subject (e.g., subject of interest 410) and the second subject (e.g., unwanted subject 425) within the first image preview frame 400a, which is an unedited preview frame. In some aspects, the identified subjects determined for an image frame by the image processing engine 450 can include humans, objects, etc., that appear within the one or more preview frames captured and generated by the mobile camera device.

In one illustrative example, the subject identification can be performed based on the image processing engine 450 including and/or using one or more segmentation machine learning networks to determine segmentation results or segmentation information for the input image frame (e.g., the unedited, first image preview frame 400a). For example, the segmentation information can include one or more segmentation masks generated to indicate one or more locations, areas, and/or pixels within a frame of image data that belong to a given semantic segment (e.g., a particular object, class of objects, etc.). For example, each pixel of a segmentation mask can include a value indicating a particular semantic segment (e.g., a particular object, class of objects, etc.) to which each pixel belongs. The pixels representing the first subject of interest 410 can be grouped or associated together based on sharing or being associated with the same semantic labeling information or the same semantic segment as determined by the image processing engine 450. The pixels representing the second subject (e.g., unwanted subject 425) can be grouped or associated together based on sharing or being associated with the same, second semantic labeling information or the same second semantic segment as determined by the engine processing engine 450, etc. For example, the subject identification information indicative of the respective subjects within the first image preview frame 400a (e.g., an unedited image preview frame) can be included in subject identification information 436 determined and/or generated by the image processing engine 450 based on analyzing the first image preview frame 400a. In some aspects, the subject identification information 436 can additionally include instance map information, tracking information, AI camera information, etc. determined based on the first image preview frame 400a and/or one or more previous image preview frames included in the same stream of image preview data as the first image preview frame 400a.

In some cases, the subject identification information 436 can be determined concurrently with outputting the first image preview frame 400a for display. In some examples, the subject identification information 436 can be determined after outputting the first image preview frame 400a for display. In some aspects, the subject identification information 436 can be determined after outputting the first image preview frame 400a for display, and in response to receiving one or more user inputs 432 indicative of or corresponding to a particular location, region, or area within the first image preview frame 400a.

For example, the one or more user inputs 432 can be indicative of and/or correspond to a user selection of one or subjects of interest (e.g., such as the subject of interest 410), where the subject(s) of interest will be included in the capture corresponding to the edited image frame 400c. In examples where the subject identification information 436 is determined prior to receiving the one or more user inputs 432 indicative of the subject(s) of interest, the location of the user input 432 within the frame of the first image preview frame 400a can be compared with the respective segmentation information or subject identification instance that was determined for the user-indicated location and is included in the subject identification information 436.

In examples where the subject identification information 436 is not determined prior to receiving the one or more user inputs 432 indicative of the subject(s) of interest, receiving the one or more user inputs 432 can cause the systems and techniques to analyze the currently displayed image preview frame (e.g., first image preview frame 400a, the displayed image preview frame at the time the one or more user inputs 432 were received) to determine the subject identification information 436 and then compare the subject identification information 436 with the location(s) indicated in the one or more user inputs 432 for selecting the subject(s) of interest 410.

Based on the user input 432 indicating the subject of interest 410, and based on the segmentation information and/or other subject identification information 436 determined for the first image preview frame 400a, the image processing engine 450 can generate and output for display a second image preview frame 400b that includes a visual indication of each identified subject as either a subject of interest (e.g., subject of interest 410) or an unwanted subject 425 (e.g., subject of non-interest). The second image preview frame 400b can be based on the same image data as the first image preview frame 400a, or the second image preview frame 400b can be based on image data captured of the same scene and photographic composition but at a slightly later time than the first image preview frame 400a.

In one illustrative example, the visual indication of subjects of interest and/or non-interest can comprise a mask applied over each unwanted subject (e.g., each subject of non-interest). For instance, the unwanted subject 425 of the first image preview frame 400a can be classified as unwanted or of non-interest based on the user input 432 indicating only the subject of interest 410 as a subject of interest. Based on the determination that the unwanted subject 425 is unwanted/a subject of non-interest, the image processing engine 450 can generate and output the second image preview frame 400b to include a masked representation or masked version of the unwanted subject 425. The masked representation of the unwanted subject 425 can also be referred to herein as an “unwanted subject mask” 427 and/or a “subject of non-interest mask” 427. For example, the unwanted subject mask 427 can be generated based on the segmentation information corresponding to the respective unwanted subject 425 in the first image preview frame 400a and/or the second image preview frame 400b.

In some aspects, the unwanted subject mask 427 can be implemented based on adjusting the pixel color value(s) of the original image data corresponding to the unwanted subject 425. For example, the unwanted subject mask 427 can be represented in the second image preview frame 400b based on adjusting the pixels corresponding to the unwanted subject 425 (e.g., determined based on the segmentation information 436 and the user input 432 indicative of subjects of interest) to one or more artificial color values corresponding to the unwanted subject mask 427. In one illustrative example, the unwanted subject mask 427 can correspond to adjusting the pixels of the unwanted subject 425 within the masked image preview frame 400b to a common color representative of the mask, such as orange, gray, etc.

For example, the unwanted subject mask 427 can comprise a visual overlay generated based on a color adjustment to the pixels of image data corresponding to the unwanted subject 425. In some examples, the visual overlay color adjustment can increase or decrease the intensity (e.g., saturation) of the color(s) represented by the pixels of image data corresponding to the unwanted subject 425. In some cases, the visual overlay color adjustment can change the color(s) represented by the pixels of image data corresponding to the unwanted subject 425. In some cases, the visual overlay color adjustment can change the color information based on the original (e.g., un-changed) color information of the pixels of image data corresponding to the unwanted subject 425. For example, the color of the visual overlay of the unwanted subject mask 427 may be based at least in part on the original color of the pixels corresponding to the unwanted subject 425. In some examples, the color of the visual overlay of the unwanted subject mask 427 can be a configured color (e.g., gray, etc.) that is independent of the original color of the pixels corresponding to the unwanted subject 425. In some examples, the unwanted subject mask 427 can comprise a visual overlay generated based on an opacity adjustment to the pixels of image data corresponding to the unwanted subject 425. For example, the original pixels corresponding to the unwanted subject 425 may correspond to a 100% opacity, and the visual overlay opacity adjustment of the unwanted subject mask 427 can comprise adjusting the pixels of image data to a lower opacity (e.g., 75% opacity, 50% opacity, etc.). In some examples, the unwanted subject mask 427 can comprise a visual overlay generated based on one or more of a color adjustment and/or an opacity adjustment to the pixels of image data corresponding to the unwanted subject 425. In some aspects, the unwanted subject mask 427 can comprise a visual overlay based on adjusting the color and adjusting the opacity for one or more pixels of the pixels of image data corresponding to the unwanted subject 425.

In some cases, the unwanted subject mask 427 can be based on rendering the pixels corresponding to the unwanted subject 425 in grayscale, while the remaining pixels of the image preview frame 400b remain in color. In some examples, the unwanted subject mask 427 can be semi-opaque or semi-transparent, corresponding to a colored (or gray/grayscale) overlay over the pixels of the unwanted subject 425, without replacing the pixels of the unwanted subject 425 with solid color pixels that would obscure or remove the details of the unwanted subject 425 within the masked image preview frame 400b.

In some examples, each subject of the plurality of subjects included within a frame of image data may initially be displayed with a corresponding unwanted subject mask (e.g., such as the unwanted subject mask 427 associated with unwanted subject 425) overlaid on the respective pixels of image data corresponding to each subject of the plurality of subjects. For example, the first image preview frame 400a includes the first subject (e.g., subject of interest 410) and the second subject (e.g., unwanted subject 425).

In some aspects, prior to performing a classification to determine or predict subjects of interest and subjects of non-interest, and/or prior to receiving the one or more user inputs 432 indicative of a subject of interest, the systems and techniques may be configured to generate the edited image preview frame 400b to include a respective mask overlay for each identified subject in the image frame. For example, the edited image preview frame 400b can be generated to include a first mask overlaid on the pixels corresponding to the first subject (e.g., subject of interest 410), and can include a second mask (e.g., the mask 427) overlaid on the pixels corresponding to the second subject (e.g., unwanted subject 425).

Based on each subject within the image frame initially being displayed with a corresponding subject mask overlay, the one or more user inputs 432 can comprise an indication or selection of the particular masked subjects that should be kept in the final edited image capture. For example, the one or more user inputs 432 can comprise a touch gesture or other selection of a subject mask that is displayed in the intermediate edited image preview (e.g., second image preview frame 400b), indicating that the selected subject should be kept in the final composition (e.g., the selected subject is a subject of interest and should not be removed). Based on the user input 432 indicating or corresponding to a particular subject mask in the edited image preview frame 400b, the mask overlay can be removed from each selected subject, indicating that the selected subject is a subject of interest and will be kept (e.g., not removed) from the final edited image composition or capture. In some cases, an additional user input 432 may be received indicative of a selection of a subject that was previously selected for removal of the subject mask. The additional user input can cause the subject to be classified (e.g., re-classified) as a subject of non-interest, and the edited image preview frame 400b can be updated to again show the corresponding subject mask overlaid on the pixel data of the selected subject. In some cases, the edited image preview frame 400b can be generated to include the respective unwanted subject mask for each subject of the plurality of subjects included in the image preview frame 400b. If no user input is received indicating a selection of a subject to keep, the final image output or capture corresponding to the third image frame 400c can be generated based on each subject of the plurality of subjects being classified as an unwanted subject (e.g., subject of non-interest) and removed.

In some aspects, the second image preview frame 400b can be a masked image preview frame that is generated and included in the stream of image preview frames or image preview data that is output for display to the user by the image processing engine 450. Based on the masked image preview frame 400b being output for display, the user of the mobile camera device that includes or implements the image processing engine 450 can be presented with a real-time preview or simulation of what the edited image frame will look like when the unwanted subject(s) (e.g., such as the unwanted subject 425, corresponding to the unwanted subject mask 427) is removed and replaced with an inpainted pixel region. For example, as noted above, the edited image frame can correspond to the third image frame 400c that is generated and output for display by the image processing engine 450.

In some examples, the edited composition with the unwanted subject 425 masked but not removed from the image can be output for display to the user prior to receiving a user input indicative of a command to capture an edited image frame. For example, the masked image preview frame 400b can be output for display to the user prior to receiving the user input 462 to capture the edited image frame 400c. In some aspects, the masked image preview frame 400b and/or the unwanted subject mask 427 can be referred to as a simulated edited image composition, or a simulation of the edited captured image frame that will be obtained if the user provides the user input 462 indicative of the image capture command or trigger. For example, the unwanted subject mask 427 can simulate the final, edited composition of edited image frame 400c with the unwanted subject 425 fully removed, based on the masked image preview frame 400b implementing or including the unwanted subject mask 427 to desaturate or gray out the unwanted subject 425 and corresponding pixels that will be removed and replaced with an inpainted pixel region 470 in the final, edited image composition captured for the edited image frame 400c obtained in response to the user input 462 indicative of the command to capture an image frame.

In some aspects, the edited image frame 400c (e.g., with the unwanted subject 425 removed and replaced with an inpainted pixel region 470) can be generated as an additional preview frame of the stream of preview frames or image preview data, and can be output for display to the user as a simulation or representation of what the edited, captured image composition will look like, where the edited preview frame with the unwanted subject 425 removed is output for display prior to receiving the user input 462 indicative of a command to capture the edited image frame. In one illustrative example, the third image frame 400c can be an additional edited preview frame that can be output for display to the user (e.g., by the image processing engine 450), prior to the image processing engine 450 receiving the user input 462 indicative of the image capture command or trigger.

In some aspects, the image processing engine 450 can be used to generate one or edited image frames corresponding to one or more video frames received as input. For example, the first image preview frame 400a can be a video preview frame included in a sequence of a plurality of video preview frames. In some aspects, the edited image preview frame 400b (e.g., with subject masking applied) may be a video preview frame included in or associated with a sequence of a plurality of video preview frames. For example, the edited image preview frame 400b can be an edited video preview frame generated based on an original video preview frame (e.g., corresponding to the first image preview frame 400a, etc.).

In some aspects, the one or more user inputs 432 indicative of the one or more subjects of interest (e.g., the one or more subjects to keep in the final or output edited composition frame such as the edited image frame 400c) can be received based on outputting for display a plurality of edited video preview frames, such as the edited second image preview frame 400b. The user input indicative of the command to capture 462 can be a user input indicative of a command to capture a video. Capturing the video can comprise capturing a plurality of image frames (e.g., video frames) in a sequential order corresponding to playback of the captured video. In some aspects, the user input 432 indicative of the subjects of interest (e.g., subjects to keep) received for an edited video preview frame (e.g., corresponding to the second, edited image preview frame 400b, etc.) can be used to capture a plurality of edited video output frames, where each edited video output frame is edited to remove and infill the pixel area corresponding to each respective subject of non-interest (e.g., as noted above with respect to the edited image frame 400c, etc.).

In some cases, during active video recording, one or more output frames presented for display to the user can be the same as or similar to the edited video preview frame (e.g., corresponding to the second image preview frame 400b, etc.) noted above. For example, during active video recording (e.g., after the user input 462 indicative of the command to capture the video frames), the edited preview frames (e.g., such as second image preview frame 400b, etc.) can be output for display to include the unwanted subject mask 427 over each unwanted subject (e.g., subject of non-interest). During active video recording, the image capture device may simultaneously capture and generate the edited image frames (e.g., such as edited image frame 400c, etc.) that replace the pixels of the unwanted subject with generated infill pixel data. During active video recording, one or more additional user inputs 432 may be received, indicative of a user selection to toggle one or more of the subjects from a subject of non-interest classification to a subject of interest classification (e.g., causing the image processing engine 450 to begin generating the subsequent edited image frame 400c to now include the previously removed subject(s)), and/or indicative of a user selection to toggle one or more of the subjects from a subject of interest classification to a subject of non-interest classification (e.g., causing the image processing engine 450 to begin generating the subsequent edited video output frames to no longer include (e.g., to now remove) the previously included subject(s)).

Based on the image processing engine 450 generating the masked image preview frame 400b indicative of one or more unwanted subject masks 427 that will be removed in the corresponding captured image frame, and/or generating the edited image frame 400c with the unwanted subject 425 removed and replaced with the inpainted pixel region 470, the systems and techniques described herein can allow a user (e.g., of the associated mobile camera device) to specify and adjust a desired photographic composition for an image capture, prior to performing the image capture. For example, the user can specify a desired photographic composition for an image of a scene based on one or more user inputs and/or user interactions with an output stream of image data corresponding to live image previews that are obtained prior to image capture (e.g., before receiving a user input to capture an image frame, such as the user input 462 to the image processing engine 450, indicative of the command to capture the edited image frame 400c). In some aspects, the user selection input(s) 432 of the subject(s) of interest (e.g., subject of interest 410) that should be kept and included in the edited image frame 400c can be associated with a more intuitive user experience than requiring the user to provide inputs indicative of the particular subjects that are to be removed. For example, a desired photographic composition may include a greater number of unwanted subjects 425 than the number of subjects of interest 410 (e.g., with the number of subjects of interest 410 being equal to one in many examples of portrait photography).

As noted above, the image processing engine 450 can be configured to determine subject identification information 436 to identify the respective subjects included in an input comprising or corresponding to the first image frame 400a (e.g., a preview frame). In some aspects, the subject identification information 436 can further include subject differentiation information (e.g., object information) that is determined based at least in part on using one or more machine learning networks and/or various other detection and estimation techniques implemented by the image processing engine 450. For example, the subject differentiation information can be indicative of a prediction and/or classification of each respective subject of the set of identified subjects determined for the first image preview frame 400a, where the prediction or classification indicates whether each identified subject is a subject of interest (e.g., such as subject of interest 410), or is a subject of non-interest (e.g., such as the unwanted subject 425) that will be removed (e.g., not included) in the edited image frame 400c captured and/or outputted.

In some aspects, the subject differentiation information determined by the image processing engine 450 for the identified subjects within the first image preview frame 400a and/or the second image preview frame 400b can be determined using one or more machine learning networks and/or based on segmentation information 466 (e.g., segmentation map, etc.) corresponding to the first image preview frame 400a or the second image preview frame 400b. In some cases, the segmentation information 466 (e.g., segmentation map, etc.) can be generated by an image segmentation (e.g., image semantic segmentation) machine learning network associated with the subject identification information 436. In some examples, the segmentation information associated with the subject differentiation performed by the image processing engine 450 can be the same as the segmentation information associated with the subject detection or identification performed earlier by the image processing engine 450, for the same input image (e.g., first image preview frame 400a, second image preview frame 400b, etc.).

In some examples, the subject differentiation information can be determined based on predicted subject classification information determined by one or more machine learning networks implemented by the image processing engine 450. In some cases, the subject differentiation information can be determined based on one or more user inputs indicative of a selection and/or identification of one or more subjects within the image frame as subjects of interest or subjects of non-interest, such as the one or more user inputs 432.

In one illustrative example, the subject differentiation information can be determined based on a combination of predicted subject classifications determined by one or more machine learning networks of the image processing engine 450, and one or more subsequent user inputs indicative of an acceptance (e.g., confirmation) or an edit to one or more of the predicted subject classifications associated with the initial, machine learning-based subject differentiation.

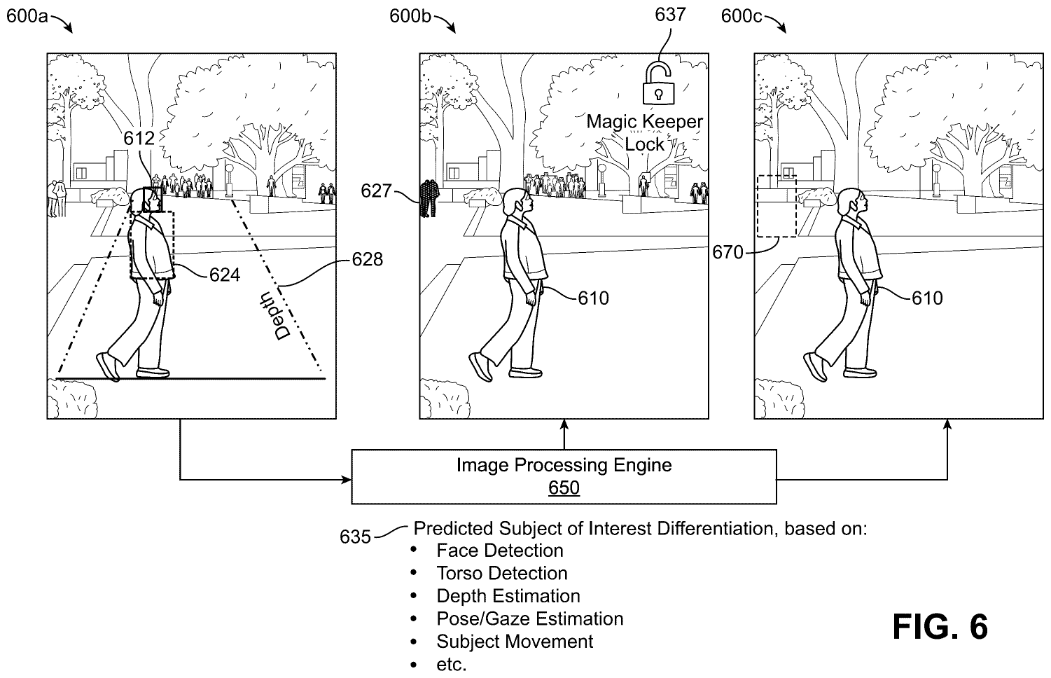

For example, FIG. 6 is a diagram illustrating an example of an image processing system including an image processing engine 650 that can be the same as or similar to the image processing engine 450 of FIG. 4. A first image frame 600a of FIG. 6 can be the same as or similar to the first (e.g., unedited preview frame) image frame 400a of FIG. 4. A second image frame 600b of FIG. 6 can be the same as or similar to the second (e.g., edited or masked frame) image preview frame 400b of FIG. 4. A third image frame 600c of FIG. 6 can be the same as or similar to the third (e.g., output or edited image capture frame) image frame 400c of FIG. 4.

In some aspects, the subject differentiation information (e.g., object information) described above can be included in predicted subject differentiation information 635 (e.g., also referred to as predicted object information 635) determined by the image processing engine 650 of FIG. 6. For example, the subject differentiation information 635 can comprise an output prediction indicative of whether an identified subject within the first image frame 600a and/or the second image frame 600b is a subject of interest or an unwanted subject (e.g., subject of non-interest).

The subject differentiation information 635 can be determined by the image processing engine 650, for example based on face detection information indicative of a pixel location or region within one or more of the first image frame 600a and the second image frame 600b for each respective human face of one or more human faces that are detected within the. In some examples, the human faces are detected within the input image preview frame based on determining detected facial features for one or more objects of a plurality of objects in the scene. For example, the face detection information for the first image frame 600a can correspond to one or more detected facial features 612, etc. In some cases, the subject differentiation information 635 can be determined based on or using torso detection information, indicative of respective pixel locations or regions within one or more of the first image frame 600a and the second image frame 600b for each respective human torso of one or more human torsos that are detected. For example, the torso detection information for the first image frame 600a can correspond to one or more detected torso features 624, etc. In some examples, the human torsos are detected within the input image preview frame based on determining detected torso features for the one or more objects of the plurality of objects in the scene.

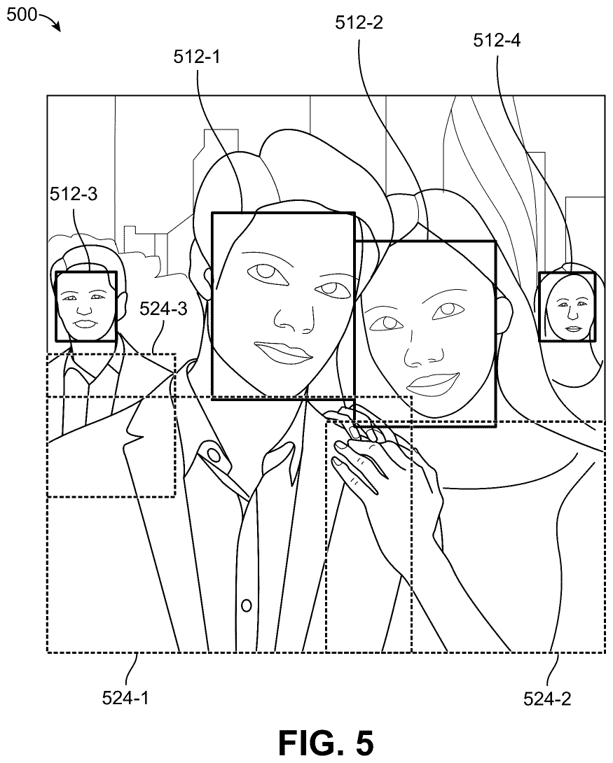

For example, FIG. 5 is a diagram illustrating an example of face and torso detection associated with an image frame 500, in accordance with some examples. The image frame 500 includes multiple different human subjects, which can be identified as separate subject instances in subject detection or identification information determined by the image processing engine 450 of FIG. 4 and/or 650 of FIG. 6, and/or which can be differentiated as either a subject of interest or unwanted subject of non-interest in subject differentiation information determined by the image processing engine 450 of FIG. 4 and/or 650 of FIG. 6.

In some aspects, face detection can be performed to detect individual and/or distinct occurrences of pixel areas or pixel regions corresponding to human faces within the input image frame 500. For example, a first face detection result 512-1 can be indicative of a set of pixels corresponding to the face of the human subject on the left foreground of the image frame 500. A second face detection result 512-2 can be indicative of a set of pixels corresponding to the face of the human subject on the right foreground of the image frame 500. A third face detection result 512-3 can be indicative of a set of pixels corresponding to the face of the human subject on the left background of the image frame 500. A fourth face detection result 512-4 can be indicative of a set of pixels corresponding to the face of the human subject on the right background of the image frame 500.

Torso detection can be performed for the image frame 500, concurrently with the face detection and/or separately (e.g., before, after, or both) from the face detection also performed for the image frame 500. For example, the torso detection can be performed for the image frame 500 and may correspond to generating or determining a first torso detection result 524-1 indicative of a set of pixels corresponding to the torso of the human subject in the left foreground of the image frame 500. A second torso detection result 524-2 can be indicative of a set of pixels corresponding to the torso of the human subject in the right foreground of the image frame 500. A third torso detection result can be indicative of a set of pixels corresponding to the torso of the human subject in the left background of the image frame 500.

In some aspects, the face detection results 512-1, 512-2, 512-3, 512-4, etc., can be correlated with the torso detection results 524-1, 524-2, 524-3, etc., to generate an instance map where the image processing engine 450, 650 attempts to map a respective face detection result and a respective torso detection result to a particular subject instance of a subject identified within the image frame 500. For example, four face detection results are determined, corresponding to the four different human subjects within the image frame 500. The instance map can include a respective instance for each of the four face detection results 512-1, 512-2, 512-3, 512-4. A lesser number (e.g., three) of torso detection results are determined for the same image frame 500, and correlation can be performed to determine which face detection result (e.g., which human subject instance in the instance map information) is associated with a particular torso detection result. For example, the first torso detection result 524-1 can be mapped to the human subject instance that is also associated with the first face detection result 512-1 (e.g., the left foreground human subject). The second torso detection result 524-2 can be mapped to the human subject instance that is also associated with the second face detection result 512-2 (e.g., the right foreground human subject). The third torso detection result 524-3 can be mapped to the human subject instance that is also associated with the third face detection result 512-3 (e.g., the left background human subject). The human subject instance that is associated with the fourth face detection result 512-4 (e.g., the right background human subject) can remain unmapped or unassociated with a torso detection result, indicating that no torso was found in the image frame 500 for the human subject of the fourth face detection result 512-4.

In some aspects, the systems and techniques can generate and update an instance map to correlate and track respective subjects across the multiple preview frames that are generated by the mobile camera device. For example, a human subject can be identified in a first preview frame based on segmentation information, face detection information, torso detection information, depth information, pose information, gaze information, etc. The human subject identified or determined within the first preview frame can be associated to a particular location within the first preview frame. The human subject identified or determined within the first preview frame can be mapped to a corresponding subject instance or subject identifier in the instance map information. For one or more subsequent preview frames (e.g., a second preview frame, third preview frame, etc., captured after the first preview frame), respective subject identification information determined for the subsequent frame can be compared to, analyzed against, and/or otherwise correlated with the existing subject instance information within the instance map.

In some aspects, the subject differentiation information 635 determined by the image processing engine 650 of FIG. 6 can be determined based on or using depth estimation information indicative of one or more depths (e.g., distances from the camera or imaging sensor, distances from a reference location or reference depth within the image frame 600a, 600b, etc.) associated with each identified subject. For example, the depth estimation information can be the same as or similar to the depth estimation information 628 associated with the first image frame 600a of FIG. 6. The foreground human subject can be associated with a smaller depth value than the background human subjects at the back left of the image frame 600a, etc.

In some aspects, the subject differentiation information 635 can be determined based on or using pose and/or gaze estimation information determine for one or more of the identified human subject. For example, the foreground human subject in the first image frame 600a may be associated with pose and/or gaze information indicating that the human subject is facing to the right and/or is oriented with a gaze 90-degrees offset from the imaging axis of the mobile camera device. The background human subjects in the upper left of the first image frame 600a may be associated with poise and/or gaze information indicating that the background human subjects are facing away from the camera and are oriented with a gaze direction that is 180-degrees offset from the imaging axis of the mobile camera device, etc.

In some aspects, the subject differentiation information 635 can be determined based on or using subject movement information determined based on comparing the respective locations of a particular subject across multiple different (e.g., consecutive, successive, sequential, etc.) image preview frames 600a, 600b, etc., included in the same stream of image preview data.

In one illustrative example, the second image frame 600b of FIG. 6 can be generated by the image processing engine 650 to include an unwanted subject mask 627 overlaid on top of the human subjects at the back left of the image frame 600b, and without any masking applied to or overlaid on top of the human subject at the center foreground of the image frame 600b. In some aspects, the second image frame 600b can include the unwanted subject mask 627 to visually indicate to a user the predicted subject differentiation information 635 that was determined automatically by the image processing engine 650, for example using one or more machine learning networks to determine, analyze, and/or compare face detection, torso detection, depth estimation, pose/gaze estimation, movement estimation, etc., type information determined for the second image frame 600b as noted above.

In some aspects, the second image frame 600b and unwanted subject mask 627 can be indicative of an auto-suggestion of unwanted subjects that are differentiated from predicted subjects of interest 610 automatically by the image processing engine 650. For example, the auto-suggestion can be indicated based on the unwanted subject mask 627 applied to each subject that is associated with an unwanted or non-interest prediction or classification in the subject differentiation information 635.

In some aspects, the second image frame 600b can be output for display by the image processing engine 650 in combination with a graphical user interface (GUI) element 637 that can be selected by the user to accept the auto-suggestion and/or predicted subject differentiation information 635 determined for the image frame 600b by the image processing engine 650. For example, user selection of the GUI element 637 (e.g., which can be a ‘Lock’ or ‘Accept’ GUI element, etc.) can comprise a user input indicative of the user accepting the auto-suggestion and the predicted subject differentiation information 635 determined by the image processing engine 650.

Selection of the ‘Lock’ GUI element 637 by the user can cause the image processing engine 650 to lock the image composition to include only the subjects of interest 610 that were identified as subjects of interest at the time the ‘Lock’ GUI element 637 was selected by the user input. For example, after locking the image composition to the subjects of interest 610 included in the auto-suggestion and predicted subject differentiation information 635, the scene within the stream of image preview frames (e.g., the stream of image preview frames including the first image frame 600a and the second image frame 600b, etc.) can be continuously or periodically analyzed by the image processing engine 650 to determine updated subject identification information and/or instance map information as previously identified and detected subjects leave the frame in subsequent image preview frames, and/or as new or previously unidentified and undetected subjects enter the frame in subsequent image preview frames.

Based on the selection of the ‘Lock’ GUI element 637 to lock the image composition to the subjects of interest 610 identified at the time of receiving the user input selecting the ‘Lock’ GUI element 637, any newly detected or identified subjects that subsequently enter the frame will be automatically differentiated and classified as subjects of non-interest and will be removed and replaced with corresponding inpainted pixel data of the pixel region 670 in the final image capture corresponding to the third (e.g., edited) image frame 600c that is obtained in response to receiving a user input to capture an image frame. For example, the image processing engine 650 can be configured to automatically exclude any new or additional subjects detected within the frame from being classified as subjects of interest 610 after the composition has been locked by the user to the subjects of interest 610. Automatically excluding any new or additional subjects detected within the frame after locking the composition to the subjects of interest 610 can correspond to automatically removing and inpainting the corresponding pixel region 670 for each subject that is not a locked subject of interest 610, when capturing the final image frame (e.g., third image frame 600c) in response to the user input to capture an image frame.

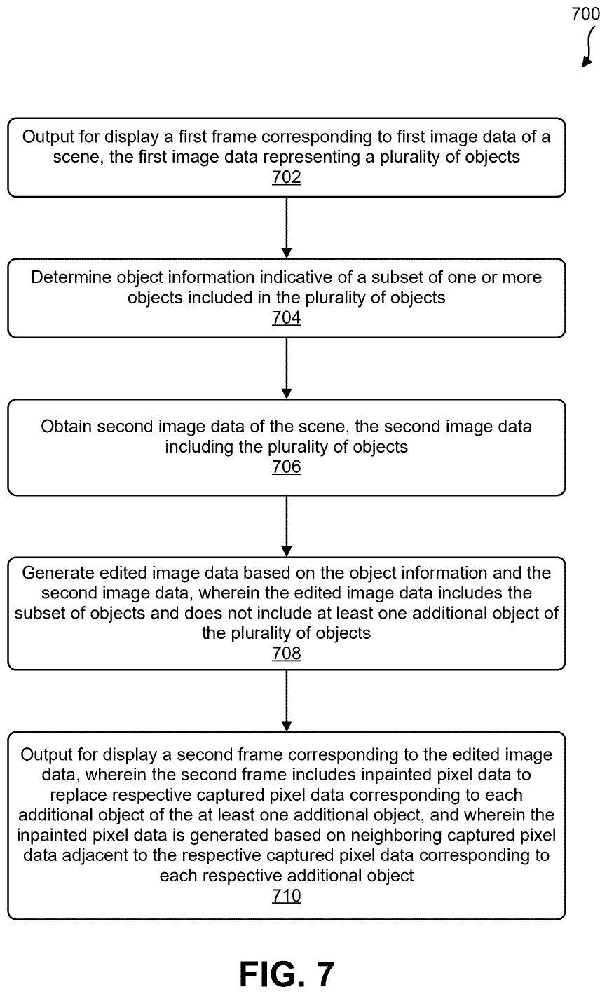

FIG. 7 is a flowchart diagram illustrating an example of a process 700 for processing image and/or video data. In some examples, the process 700 can be performed by a computing device or apparatus or a component or system (e.g., one or more chipsets, one or more processors such as one or more CPUs, DSPs, NPUs, NSPs, microcontrollers, ASICs, FPGAS, programmable logic devices, discrete gates or transistor logic components, discrete hardware components, etc., any combination thereof, and/or other component or system) of the computing device or apparatus. For example, the process 700 can be performed by a mobile camera device, among various others, etc. The operations of the process 700 may be implemented as software components that are executed and run on one or more processors (e.g., processor 810 of FIG. 8 or other processor(s)).

At block 702, the computing device (or component thereof) can output for display a first frame corresponding to first image data of a scene, the first image data representing a plurality of objects. For example, the first frame can comprise a first preview frame obtained prior to receiving a command to capture a frame. In some aspects, the first frame is a first preview frame obtained prior to receiving a command to capture a frame corresponding to an edited image data.

In some examples, the first frame can be the same as or similar to the first frame 300 of FIG. 3A, the first image preview frame 400a of FIG. 4, and/or the image preview frame 400b of FIG. 4. In some cases, the first frame can be the same as or similar to the first image frame 600a and/or the second image frame 600b of FIG. 6 (e.g., image preview frames, etc.). The first frame can be an image frame and/or can be a video frame. In some examples, the first frame can include a plurality of objects, such as the subject of interest 310 and/or the unwanted subject 325 of FIGS. 3A and 3B, the subject of interest 410 and/or the unwanted subject 425 of FIG. 4, and/or the subject of interest 610 and/or the unwanted subject corresponding to the unwanted subject mask 627 of FIG. 6, etc.

At block 704, the computing device (or component thereof) can determine object information indicative of a subset of one or more objects included in the plurality of objects. For example, the object information may be subject differentiation information. In some examples, the subset of one or more objects included in the plurality of objects can be a subset of subjects included in a plurality of subjects in the first frame. In some cases, the subset of one or more objects can be a subset of one or more subjects of interest. For example, the subset of one or more objects can include a subject of interest, such as the subject(s) of interest 310 of FIGS. 3A and 3B, the subject of interest 410 of FIG. 4, the subject of interest 610 of FIG. 6, etc.

In some cases, the object information indicative of the subset of one or more objects can be determined based on the one or more user inputs 432 of FIG. 4. In some examples, the object information is based on one or more of face detection information generated for at least a portion of the plurality of objects, torso detection information generated for at least a portion of the plurality of objects, depth estimation information generated for at least a portion of the plurality of objects, pose or gaze information generated for at least a portion of the plurality of objects, or movement information determined for at least a portion of the plurality of objects. In some examples, the object information can be determined using the image processing engine 450 of FIG. 4 and the segmentation, instance map, and/or tracking information 436 of FIG. 4. In some cases, the object information can be determined using the image processing engine 650 of FIG. 6, and the predicted subject of interest differentiation information 635 of FIG. 6. In some aspects, the predicted subject of interest differentiation information 635 of FIG. 6 can comprise the object information.

In some cases, determining the object information includes using one or more machine learning networks to determine predicted object information for each respective object of the plurality of objects, wherein the predicted object information is indicative of a classification of the respective object within the subset of one or more objects (e.g., a subject of interest) or within the at least one additional object (e.g., a subject of non-interest).

At block 706, the computing device (or component thereof) can obtain second image data of the scene, the second image data including the plurality of objects. In some examples, the first image data comprises a first preview frame, such as the first (e.g., original) image preview frame 400a of FIG. 4 or the first (e.g., original) image preview frame 600a of FIG. 6. The second image data can correspond to a second preview frame that is captured or obtained after the first preview frame. For example, the second image data of the scene can correspond to the edited image preview frame 400b of FIG. 4 with unwanted subject masking, the edited image preview frame 600b of FIG. 6 with unwanted subject masking, etc. In some examples, the second image data can be an edited captured image frame of the scene, such as the edited image frame 400c of FIG. 4 and/or the edited image frame 600c of FIG. 6.

At block 708, the computing device (or component thereof) can generate edited image data based on the object information and the second image data, wherein the edited image data includes the subset of objects and does not include at least one additional object of the plurality of objects. For example, the edited image data can correspond to the edited image preview frame 400b of FIG. 4 with unwanted subject masking, and/or can correspond to the edited image preview frame 600b of FIG. 6 with unwanted subject masking, etc. In some examples, the edited image data can correspond to the edited captured image frame of the scene, such as the edited image frame 400c of FIG. 4 and/or the edited image frame 600c of FIG. 6, etc.

For example, the edited image frame 400c of FIG. 4 can include the subject of interest 410 of FIG. 4 as the subset of objects, and does not include the subject of non-interest (e.g., unwanted subject 425) of FIG. 4 as the at least one additional object. In another example, the edited image data of third image frame 600c of FIG. 6 can include the subject of interest 610 of FIG. 6 as the subset of objects, and does not include the subject of non-interest associated with the unwanted subject mask 627 of FIG. 6 as the at least one additional object.

At block 710, the computing device (or component thereof) can output for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object. For example, the second frame corresponding to the edited image data can be the same as or similar to an edited captured image frame of the scene, such as the edited image frame 400c of FIG. 4 and/or the edited output of third image frame 600c of FIG. 6.

In some cases, the computing device (or component thereof) can receive a command to capture the second frame corresponding to the edited image data. For example, the command to capture can be the same as or similar to the user input 462 of FIG. 4. In some cases, the second frame is a captured frame, and wherein outputting the second frame is based on receiving the command to capture the second frame. In some examples, the first frame is a preview frame, and the captured frame is the edited image data.

In some cases, generating the edited image data includes outputting for display an edited preview frame corresponding to the edited image data and including a masked representation of each respective additional object of the at least one additional object, wherein the edited preview frame is output subsequent to the first frame and prior to receiving the command to capture the second frame. For example, the masked representation of an additional object can be the same as or similar to the unwanted subject mask 427 of FIG. 4, and/or the unwanted subject mask 627 of FIG. 6.

In some cases the masked representation of each respective additional object is generated based on modifying color information of corresponding pixels of image data for each respective additional object. For example, the masked representation of each respective additional object can be generated based on reducing a saturation of the corresponding pixels of image data for each respective additional object. In some cases, the masked representation of each respective additional object can be generated based on converting the corresponding pixels of image data for each respective additional object to grayscale.

In some examples, the masked representation of each respective additional object comprises a visual overlay on the edited preview frame, where the visual overlay is on top of one or more pixels of image data corresponding to each respective additional object. In some cases, the edited preview frame is different from the captured frame. In some examples, the second frame is a captured frame generated based on receiving a command to capture a frame corresponding to the edited image data. For example, the command to capture a frame corresponding to the edited image data can be the same as or similar to the user input 462 indicative of the command to capture the edited image frame.

In some cases, the second frame includes respective captured pixel data corresponding to each object of the subset of objects, and does not include captured pixel data corresponding to the at least one additional object. For example, the second frame can be the edited image frame 400c, and can include respective captured pixel data corresponding to the subject of interest 410 (e.g., object of the subset of objects), and does not include captured pixel data corresponding to the subject of non-interest (e.g., unwanted subject 42) as the at least one additional object.

In some cases, generating the edited image data includes determining segmentation information for the plurality of objects, where the segmentation information is determined based on one or more of the first image data or the second image data. In some cases, generating the edited image data further includes determining, based on the segmentation information and the object information, a corresponding area of captured pixel data corresponding to each respective additional object of the at least one additional object, and generating a plurality of inpainted pixels for the corresponding area of captured pixel data corresponding to each respective additional object.

For example, the corresponding area of captured pixel data can be the same as or similar to the pixel region 470 corresponding to the subject of non-interest (e.g., unwanted subject 425) of FIG. 4, and/or the pixel region 670 corresponding to the subject of non-interest associated with the unwanted subject mask 627 of FIG. 6, etc. In some cases, the plurality of inpainted pixels is generated based on neighboring (e.g., adjacent, etc.) captured pixel data associated with the corresponding area of captured pixel data corresponding to each respective additional object. In some examples, generating the edited image data further includes replacing the corresponding area of captured pixel data corresponding to each respective additional object with the plurality of inpainted pixels generated for the respective additional object.

In some cases, the first frame comprises a first preview frame obtained prior to receiving a command to capture a frame corresponding to the edited image data, and the second frame comprises a second preview frame obtained subsequent to the first preview frame and prior to receiving the command to capture the frame corresponding to the edited image data.

In some cases, the computing device (or component thereof) can be further configured to receive a command to capture a frame corresponding to the edited image data, where the command is received subsequent to outputting the second frame. The computing device (or component thereof) can generate a captured image corresponding to the edited image data, where the captured image is generated based on removing the at least one additional object from captured image data of the scene obtained in response to receiving the command.

In some cases, the captured image and the second frame are different. In some examples, the captured image is associated with a higher (e.g., larger, greater, etc.) resolution than the second frame. For example, the resolution of the captured image can be a relatively high resolution corresponding to an image capture resolution of a camera device, and the resolution of the second frame can be a relatively low resolution corresponding to an image preview resolution of the camera device, etc. In some cases, the computing device (or component thereof) can be further configured to output for display a captured frame of the captured image, wherein the captured frame is output for display subsequent to receiving the command to capture the frame.

In some examples, the second frame is generated as an output of a live image preview processing pipeline included in a mobile camera device. In some cases, the captured frame is generated as an output of an image capture image processing pipeline included in the mobile camera device, wherein the image capture image processing pipeline is different from the live image preview processing pipeline.

In some examples, determining the object information includes using one or more machine learning networks to determine predicted object information for each respective object of the plurality of objects, where the predicted object information is indicative of a classification of the respective object within the subset of one or more objects or within the at least one additional object. In some cases, the one or more machine learning networks can be included in the image processing engine 450 of FIG. 4 and/or the image processing engine 650 of FIG. 6, etc.

In some examples, the computing device (or component thereof) can be further configured to generate the edited image data using the predicted object information to determine the subset of objects included in the edited image data and the at least one additional object to not include in the edited image data.

In some examples, the computing device (or component thereof) can be further configured to output for display an edited preview frame indicative of a subset of objects or additional object classification included in the predicted object information for the respective objects of the plurality of objects. The computing device (or component thereof) can receive one or more user inputs indicative of one or more changes to the predicted object information. The computing device (or component thereof) can generate the edited image data using predicted object information updated based on the one or more changes.

In some examples, the processes described herein (e.g., process 700 and/or any other process described herein) may be performed by a computing device, apparatus, or system. In one example, the process 700 can be performed by a computing device or system having the computing device architecture 800 of FIG. 8. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein, including the process 700 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 700 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement the various techniques described herein. In some examples, the computing device can include a mobile device, a wearable device, an extended reality (XR) device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 800 can implement the image processing engine 450 of FIG. 4, the image processing engine 650 of FIG. 6, etc. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random-access memory (RAM) 825, to processor 810.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other engines can control or be configured to control processor 810 to perform various actions. Other computing device memory 815 may be available for use as well. Memory 815 can include multiple different types of memory with different performance characteristics. Processor 810 can include any general-purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules or engines are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects or examples. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that aspects and examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other instances, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects and examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects and examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

The various illustrative logical blocks, modules, engines, circuits, and algorithm steps described in connection with the aspects and examples disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method comprising: outputting for display a first frame corresponding to first image data of a scene, the first image data including a plurality of objects; determining object information indicative of a subset of one or more objects included in the plurality of objects; obtaining second image data of the scene, the second image data including the plurality of objects; generating edited image data based on the object information and the second image data, wherein the edited image data includes the subset of objects and does not include at least one additional object of the plurality of objects; and outputting for display a second frame corresponding to the edited image data.

Aspect 2. The method of Aspect 1, further comprising: receiving a command to capture the second frame corresponding to the edited image data.

Aspect 3. The method of Aspect 2, wherein the second frame is a captured frame, and wherein outputting the second frame is based on receiving the command to capture the second frame.

Aspect 4. The method of Aspect 3, wherein the first frame is a preview frame, and wherein the captured frame is the edited image data.

Aspect 5. The method of Aspect 4, wherein generating the edited image data includes: outputting for display an edited preview frame corresponding to the edited image data and including a masked representation of each respective additional object of the at least one additional object, wherein the edited preview frame is output subsequent to the first frame and prior to receiving the command to capture the second frame.

Aspect 6. The method of Aspect 5, wherein the masked representation of each respective additional object is generated based on modifying color information of corresponding pixels of image data for each respective additional object.

Aspect 7. The method of Aspect 6, wherein the masked representation of each respective additional object is generated based on reducing a saturation of the corresponding pixels of image data for each respective additional object.

Aspect 8. The method of any of Aspects 6 to 7, wherein the masked representation of each respective additional object is generated based on converting the corresponding pixels of image data for each respective additional object to grayscale.

Aspect 9. The method of any of Aspects 5 to 8, wherein the masked representation of each respective additional object comprises a visual overlay on the edited preview frame, wherein the visual overlay is on top of one or more pixels of image data corresponding to each respective additional object.

Aspect 10. The method of any of Aspects 5 to 9, wherein the edited preview frame is different from the captured frame.

Aspect 11. The method of any of Aspects 1 to 10, wherein the second frame is a captured frame generated based on receiving a command to capture a frame corresponding to the edited image data.

Aspect 12. The method of Aspect 11, wherein the second frame includes respective captured pixel data corresponding to each object of the subset of objects, and does not include captured pixel data corresponding to the at least one additional object.

Aspect 13. The method of Aspect 12, wherein generating the edited image data includes: determining segmentation information for the plurality of objects, the segmentation information determined based on one or more of the first image data or the second image data; determining, based on the segmentation information and the object information, a corresponding area of captured pixel data corresponding to each respective additional object of the at least one additional object; and generating a plurality of inpainted pixels for the corresponding area of captured pixel data corresponding to each respective additional object.

Aspect 14. The method of Aspect 13, wherein the plurality of inpainted pixels is generated based on neighboring captured pixel data associated with the corresponding area of captured pixel data corresponding to each respective additional object.

Aspect 15. The method of any of Aspects 13 to 14, wherein generating the edited image data further includes: replacing the corresponding area of captured pixel data corresponding to each respective additional object with the plurality of inpainted pixels generated for the respective additional object.

Aspect 16. The method of any of Aspects 1 to 15, wherein: the first frame comprises a first preview frame obtained prior to receiving a command to capture a frame corresponding to the edited image data; and the second frame comprises a second preview frame obtained subsequent to the first preview frame and prior to receiving the command to capture the frame corresponding to the edited image data.

Aspect 17. The method of Aspect 16, further comprising: receiving a command to capture a frame corresponding to the edited image data, wherein the command is received subsequent to outputting the second frame; and generating a captured image corresponding to the edited image data, wherein the captured image is generated based on removing the at least one additional object from captured image data of the scene obtained in response to receiving the command.

Aspect 18. The method of Aspect 17, wherein the captured image and the second frame are different.

Aspect 19. The method of any of Aspects 17 to 18, wherein the captured image is associated with a higher resolution than the second frame.

Aspect 20. The method of any of Aspects 17 to 19, further comprising: outputting for display a captured frame of the captured image, wherein the captured frame is output for display subsequent to receiving the command to capture the frame.

Aspect 21. The method of Aspect 20, wherein: the second frame is generated as an output of a live image preview processing pipeline included in a mobile camera device; and the captured frame is generated as an output of an image capture image processing pipeline included in the mobile camera device, wherein the image capture image processing pipeline is different from the live image preview processing pipeline.

Aspect 22. The method of any of Aspects 1 to 21, wherein the object information is based on one or more of: face detection information generated for at least a portion of the plurality of objects; torso detection information generated for at least a portion of the plurality of objects; depth estimation information generated for at least a portion of the plurality of objects; pose or gaze information generated for at least a portion of the plurality of objects; or movement information determined for at least a portion of the plurality of objects.

Aspect 23. The method of any of Aspects 1 to 22, wherein determining the object information includes: using one or more machine learning networks to determine predicted object information for each respective object of the plurality of objects, wherein the predicted object information is indicative of a classification of the respective object within the subset of one or more objects or within the at least one additional object.

Aspect 24. The method of Aspect 23, further comprising: generating the edited image data using the predicted object information to determine the subset of objects included in the edited image data and the at least one additional object to not include in the edited image data.

Aspect 25. The method of any of Aspects 23 to 24, further comprising: outputting for display an edited preview frame indicative of a subset of objects or additional object classification included in the predicted object information for the respective objects of the plurality of objects; receiving one or more user inputs indicative of one or more changes to the predicted object information; and generating the edited image data using predicted object information updated based on the one or more changes.

Aspect 26. An apparatus for processing image data, comprising: at least one memory; and at least one processor coupled to the at least one memory, the at least one processor configured to: output for display a first frame corresponding to first image data of a scene, the first image data including a plurality of objects; determine object information indicative of a subset of one or more objects included in the plurality of objects; obtain second image data of the scene, the second image data including the plurality of objects; generate edited image data based on the object information and the second image data, wherein the edited image data includes the subset of objects and does not include at least one additional object of the plurality of objects; and output for display a second frame corresponding to the edited image data.

Aspect 27. The apparatus of Aspect 26, wherein the at least one processor is further configured to: receive a command to capture the second frame corresponding to the edited image data.

Aspect 28. The apparatus of Aspect 27, wherein the second frame is a captured frame, and wherein the at least one processor is configured to output the second frame based on receiving the command to capture the second frame.

Aspect 29. The apparatus of Aspect 28, wherein the first frame is a preview frame, and wherein the captured frame is the edited image data.

Aspect 30. The apparatus of Aspect 29, wherein, to generate the edited image data, the at least one processor is configured to: output for display an edited preview frame corresponding to the edited image data and including a masked representation of each respective additional object of the at least one additional object, wherein the edited preview frame is output subsequent to the first frame and prior to receiving the command to capture the second frame.

Aspect 31. The apparatus of Aspect 30, wherein the masked representation of each respective additional object is generated based on modifying color information of corresponding pixels of image data for each respective additional object.

Aspect 32. The apparatus of Aspect 31, wherein the masked representation of each respective additional object is generated based on reducing a saturation of the corresponding pixels of image data for each respective additional object.

Aspect 33. The apparatus of any of Aspects 31 to 32, wherein the masked representation of each respective additional object is generated based on converting the corresponding pixels of image data for each respective additional object to grayscale.

Aspect 34. The apparatus of any of Aspects 30 to 33, wherein the masked representation of each respective additional object comprises a visual overlay on the edited preview frame, wherein the visual overlay is on top of one or more pixels of image data corresponding to each respective additional object.

Aspect 35. The apparatus of any of Aspects 30 to 34, wherein the edited preview frame is different from the captured frame.

Aspect 36. The apparatus of any of Aspects 26 to 35, wherein the second frame is a captured frame generated based on receiving a command to capture a frame corresponding to the edited image data.

Aspect 37. The apparatus of Aspect 36, wherein the second frame includes respective captured pixel data corresponding to each object of the subset of objects, and does not include captured pixel data corresponding to the at least one additional object.

Aspect 38. The apparatus of Aspect 37, wherein, to generate the edited image data, the at least one processor is configured to: determine segmentation information for the plurality of objects, the segmentation information determined based on one or more of the first image data or the second image data; determine, based on the segmentation information and the object information, a corresponding area of captured pixel data corresponding to each respective additional object of the at least one additional object; and generate a plurality of inpainted pixels for the corresponding area of captured pixel data corresponding to each respective additional object.

Aspect 39. The apparatus of Aspect 38, wherein the plurality of inpainted pixels is generated based on neighboring captured pixel data associated with the corresponding area of captured pixel data corresponding to each respective additional object.

Aspect 40. The apparatus of any of Aspects 38 to 39, wherein, to generate the edited image data, the at least one processor is further configured to: replace the corresponding area of captured pixel data corresponding to each respective additional object with the plurality of inpainted pixels generated for the respective additional object.

Aspect 41. The apparatus of any of Aspects 26 to 40, wherein: the first frame comprises a first preview frame obtained prior to receiving a command to capture a frame corresponding to the edited image data; and the second frame comprises a second preview frame obtained subsequent to the first preview frame and prior to receiving the command to capture the frame corresponding to the edited image data.

Aspect 42. The apparatus of Aspect 41, wherein the at least one processor is further configured to: receive a command to capture a frame corresponding to the edited image data, wherein the command is received subsequent to outputting the second frame; and generate a captured image corresponding to the edited image data, wherein the captured image is generated based on removing the at least one additional object from captured image data of the scene obtained in response to receiving the command.

Aspect 43. The apparatus of Aspect 42, wherein the captured image and the second frame are different.

Aspect 44. The apparatus of any of Aspects 42 to 43, wherein the captured image is associated with a higher resolution than the second frame.

Aspect 45. The apparatus of any of Aspects 42 to 44, wherein the at least one processor is further configured to: output for display a captured frame of the captured image, wherein the captured frame is output for display subsequent to receiving the command to capture the frame.

Aspect 46. The apparatus of Aspect 45, wherein: the second frame is generated as an output of a live image preview processing pipeline included in a mobile camera device; and the captured frame is generated as an output of an image capture image processing pipeline included in the mobile camera device, wherein the image capture image processing pipeline is different from the live image preview processing pipeline.

Aspect 47. The apparatus of any of Aspects 26 to 46, wherein the object information is based on one or more of: face detection information generated for at least a portion of the plurality of objects; torso detection information generated for at least a portion of the plurality of objects; depth estimation information generated for at least a portion of the plurality of objects; pose or gaze information generated for at least a portion of the plurality of objects; or movement information determined for at least a portion of the plurality of objects.

Aspect 48. The apparatus of any of Aspects 26 to 47, wherein, to determine the object information, the at least one processor is configured to: use one or more machine learning networks to determine predicted object information for each respective object of the plurality of objects, wherein the predicted object information is indicative of a classification of the respective object within the subset of one or more objects or within the at least one additional object.

Aspect 49. The apparatus of Aspect 48, wherein the at least one processor is further configured to: generate the edited image data using the predicted object information to determine the subset of objects included in the edited image data and the at least one additional object to not include in the edited image data.

Aspect 50. The apparatus of any of Aspects 48 to 49, wherein the at least one processor is further configured to: output for display an edited preview frame indicative of a subset of objects or additional object classification included in the predicted object information for the respective objects of the plurality of objects; receive one or more user inputs indicative of one or more changes to the predicted object information; and generate the edited image data using predicted object information updated based on the one or more changes.

Aspect 51. A method for wireless communication, comprising performing operations according to any of Aspects 26 to 50.

Aspect 52. A non-transitory computer-readable storage medium comprising instructions stored thereon which, when executed by at least one processor, causes the at least one processor to perform operations according to any of Aspects 1 to 25.

Aspect 53. A non-transitory computer-readable storage medium comprising instructions stored thereon which, when executed by at least one processor, causes the at least one processor to perform operations according to any of Aspects 26 to 50.

Aspect 54. An apparatus for wireless communication comprising one or more means for performing operations according to any of Aspects 1 to 25.

Aspect 55. An apparatus for wireless communication comprising one or more means for performing operations according to any of Aspects 26 to 50.

Aspect 56. A method comprising: outputting for display a first frame corresponding to first image data of a scene, the first image data representing a plurality of objects; determining object information indicative of a subset of one or more objects included in the plurality of objects; obtaining second image data of the scene, the second image data including the plurality of objects; generating edited image data based on the object information and the second image data, wherein the edited image data includes the subset of one or more objects and does not include at least one additional object of the plurality of objects; and outputting for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object.

Aspect 57. The method of Aspect 56, further comprising: receiving a command to capture an image; and capturing the second frame in response to the command to capture the image.

Aspect 58. The method of any of Aspects 56 to 57, wherein the first frame is a preview frame, and wherein the second frame is a captured frame including the edited image data.

Aspect 59. The method of any of Aspects 56 to 58, further comprising: outputting for display a third frame corresponding to the edited image data, wherein the third frame includes a masked representation of each respective additional object of the at least one additional object, wherein the masked representation is based on modifying color information of one or more pixels of image data corresponding to the respective additional object; and wherein the third frame is output prior to receiving a command to capture the second frame.

Aspect 60. The method of Aspect 59, wherein the masked representation comprises a visual overlay included in an edited preview frame, wherein the visual overlay for each respective additional object is based on at least one of an opacity adjustment or a color adjustment to the one or more pixels of image data corresponding to the respective additional object, and wherein the edited preview frame is the third frame.

Aspect 61. The method of any of Aspects 56 to 60, wherein: the second frame includes respective captured pixel data corresponding to each object of the subset of one or more objects; and the second frame does not include captured pixel data corresponding to the at least one additional object.

Aspect 62. The method of any of Aspects 56 to 61, wherein: the first frame comprises a first preview frame obtained prior to receiving a command to capture a frame corresponding to the edited image data; and the second frame comprises a second preview frame obtained after the first preview frame, wherein the second preview frame is obtained prior to receiving the command to capture the frame corresponding to the edited image data.

Aspect 63. The method of any of Aspects 56 to 62, wherein the second frame is output for display by an image capture graphical user interface, and wherein the method further comprises: receiving a command to capture an image corresponding to the edited image data, wherein the command is a user input associated with the image capture graphical user interface; capturing third image data of the scene in response to the command to capture the image; and generating a captured image corresponding to the edited image data, wherein the captured image is generated based on removing a representation of the at least one additional object from the third image data.

Aspect 64. The method of Aspect 63, wherein the second frame is an edited preview frame, and wherein a resolution associated with the captured image is larger than a resolution associated with one or more of the second frame or the edited image data.

Aspect 65. The method of any of Aspects 63 to 64, wherein: the second frame is generated using a live image preview processing pipeline included in a mobile camera device; and the captured image is generated using an image capture image processing pipeline included in the mobile camera device, wherein the image capture image processing pipeline is different from the live image preview processing pipeline.

Aspect 66. The method of any of Aspects 56 to 65, wherein the object information includes at least one of: face detection information generated corresponding to detected facial features for the one or more objects; or torso detection information generated corresponding to detected torso features for the one or more objects.

Aspect 67. The method of any of Aspects 56 to 66, wherein the object information includes at least one of: depth estimation information generated for at least a portion of the plurality of objects; pose or gaze information generated for at least a portion of the plurality of objects; or movement information determined for at least a portion of the plurality of objects.

Aspect 68. The method of any of Aspects 56 to 67, wherein determining the object information includes: using one or more machine learning networks to determine predicted object information for each respective object of the plurality of objects, wherein the predicted object information is indicative of a classification of the respective object within the subset of one or more objects or within the at least one additional object.

Aspect 69. The method of Aspect 68, wherein generating the edited image data includes at least one of: using the predicted object information to determine the subset of one or more objects included in the edited image data; or using the predicted object information to determine the at least one additional object to not include in the edited image data.

Aspect 70. The method of any of Aspects 68 to 69, further comprising: outputting for display an edited preview frame indicative of a subset of objects or additional object classification included in the predicted object information for the respective objects of the plurality of objects; receiving one or more user inputs indicative of one or more changes to the predicted object information; and generating the edited image data using predicted object information updated based on the one or more changes.

Aspect 71. An apparatus for processing image data, comprising: at least one memory; and at least one processor coupled to the at least one memory, the at least one processor configured to: output for display a first frame corresponding to first image data of a scene, the first image data representing a plurality of objects; determine object information indicative of a subset of one or more objects included in the plurality of objects; obtain second image data of the scene, the second image data including the plurality of objects; generate edited image data based on the object information and the second image data, wherein the edited image data includes the subset of objects and does not include at least one additional object of the plurality of objects; and output for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object.

Aspect 72. The apparatus of Aspect 71, wherein the at least one processor is configured to: receive a command to capture an image; and capture the second frame in response to the command to capture the image.

Aspect 73. The apparatus of any of Aspects 71 to 72, wherein the first frame is a preview frame, and wherein the second frame is a captured frame including the edited image data.

Aspect 74. The apparatus of any of Aspects 71 to 73, wherein the at least one processor is configured to: output for display a third frame, the third frame corresponding to the edited image data and including a masked representation of each respective additional object of the at least one additional object; receive a command to capture an image; and capture the second frame in response to the command to capture the image.

Aspect 75. The apparatus of Aspect 74, wherein the masked representation comprises a visual overlay included in an edited preview frame, wherein the visual overlay for each respective additional object is based on at least one of an opacity adjustment or a color adjustment to the one or more pixels of image data corresponding to the respective additional object, and wherein the edited preview frame is the third frame.

Aspect 76. The apparatus of any of Aspects 71 to 75, wherein: the second frame includes respective captured pixel data corresponding to each object of the subset of one or more objects; and the second frame does not include captured pixel data corresponding to the at least one additional object.

Aspect 77. The apparatus of any of Aspects 71 to 76, wherein: the first frame comprises a first preview frame obtained prior to receiving a command to capture a frame corresponding to the edited image data; and the second frame comprises a second preview frame obtained after the first preview frame, wherein the second preview frame is obtained prior to receiving the command to capture the frame corresponding to the edited image data.

Aspect 78. The apparatus of any of Aspects 71 to 77, wherein the second frame is output for display by an image capture graphical user interface, and wherein the at least one processor is further configured to: receive a command to capture an image corresponding to the edited image data, wherein the command is a user input associated with the image capture graphical user interface; capture third image data of the scene in response to the command to capture the image; and generate a captured image corresponding to the edited image data, wherein the captured image is generated based on removing a representation of the at least one additional object from the third image data.

Aspect 79. The apparatus of Aspect 78, wherein the second frame is an edited preview frame, and wherein a resolution associated with the captured image is larger than a resolution associated with one or more of the second frame or the edited image data.

Aspect 80. The apparatus of any of Aspects 78 to 79, wherein: the second frame is generated using a live image preview processing pipeline included in a mobile camera device; and the captured image is generated using an image capture image processing pipeline included in the mobile camera device, wherein the image capture image processing pipeline is different from the live image preview processing pipeline.

Aspect 81. The apparatus of any of Aspects 71 to 80, wherein the object information includes at least one of: face detection information generated corresponding to detected facial features for the one or more objects; or torso detection information generated corresponding to detected torso features for the one or more objects.

Aspect 82. The apparatus of any of Aspects 71 to 81, wherein the object information includes at least one of: depth estimation information generated for at least a portion of the plurality of objects; pose or gaze information generated for at least a portion of the plurality of objects; or movement information determined for at least a portion of the plurality of objects.

Aspect 83. The apparatus of any of Aspects 71 to 82, wherein, to determine the object information, the at least one processor is configured to: use one or more machine learning networks to determine predicted object information for each respective object of the plurality of objects, wherein the predicted object information is indicative of a classification of the respective object within the subset of one or more objects or within the at least one additional object.

Aspect 84. The apparatus of Aspect 83, wherein, to generate the edited image data, the at least one processor is configured to: use the predicted object information to determine the subset of one or more objects included in the edited image data; or use the predicted object information to determine the at least one additional object to not include in the edited image data.

Aspect 85. The apparatus of any of Aspects 83 to 84, wherein, to generate the edited image data, the at least processor is configured to: use the predicted object information to determine the subset of one or more objects included in the edited image data.

Aspect 86. The apparatus of any of Aspects 83 to 85, wherein, to generate the edited image data, the at least processor is configured to: use the predicted object information to determine the at least one additional object to not include in the edited image data.

Aspect 87. The apparatus of any of Aspects 83 to 86, wherein the at least one processor is configured to: output for display an edited preview frame indicative of a subset of objects or additional object classification included in the predicted object information for the respective objects of the plurality of objects; receive one or more user inputs indicative of one or more changes to the predicted object information; and generate the edited image data using predicted object information updated based on the one or more changes.

Aspect 88. A non-transitory computer-readable storage medium comprising instructions stored thereon which, when executed by at least one processor, causes the at least one processor to perform operations according to any of Aspects 56 to 70.

Aspect 89. An apparatus for wireless communication comprising one or more means for performing operations according to any of Aspects 56 to 70.

What is claimed is:

1. A method comprising:
outputting for display a first frame corresponding to first image data of a scene, the first image data representing a plurality of objects;
determining object information indicative of a subset of one or more objects included in the plurality of objects;
obtaining second image data of the scene, the second image data including the plurality of objects;
generating edited image data based on the object information and the second image data, wherein the edited image data includes the subset of one or more objects and does not include at least one additional object of the plurality of objects; and
outputting for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object.

2. The method of claim 1, further comprising:
receiving a command to capture an image; and
capturing the second frame in response to the command to capture the image.

3. The method of claim 1, wherein the first frame is a preview frame, and wherein the second frame is a captured frame including the edited image data.

4. The method of claim 1, further comprising:
outputting for display a third frame corresponding to the edited image data,
wherein the third frame includes a masked representation of each respective additional object of the at least one additional object, wherein the masked representation is based on modifying color information of one or more pixels of image data corresponding to the respective additional object; and
wherein the third frame is output prior to receiving a command to capture the second frame.

5. The method of claim 4, wherein the masked representation comprises a visual overlay included in an edited preview frame, wherein the visual overlay for each respective additional object is based on at least one of an opacity adjustment or a color adjustment to the one or more pixels of image data corresponding to the respective additional object, and wherein the edited preview frame is the third frame.

6. The method of claim 1, wherein:
the second frame includes respective captured pixel data corresponding to each object of the subset of one or more objects; and
the second frame does not include captured pixel data corresponding to the at least one additional object.

7. The method of claim 1, wherein:
the first frame comprises a first preview frame obtained prior to receiving a command to capture a frame corresponding to the edited image data; and
the second frame comprises a second preview frame obtained after the first preview frame, wherein the second preview frame is obtained prior to receiving the command to capture the frame corresponding to the edited image data.

8. The method of claim 1, wherein the second frame is output for display by an image capture graphical user interface, and wherein the method further comprises:
receiving a command to capture an image corresponding to the edited image data, wherein the command is a user input associated with the image capture graphical user interface;
capturing third image data of the scene in response to the command to capture the image; and
generating a captured image corresponding to the edited image data, wherein the captured image is generated based on removing a representation of the at least one additional object from the third image data.

9. The method of claim 8, wherein the second frame is an edited preview frame, and wherein a resolution associated with the captured image is larger than a resolution associated with one or more of the second frame or the edited image data.

10. The method of claim 8, wherein:
the second frame is generated using a live image preview processing pipeline included in a mobile camera device; and
the captured image is generated using an image capture image processing pipeline included in the mobile camera device, wherein the image capture image processing pipeline is different from the live image preview processing pipeline.

11. The method of claim 1, wherein the object information includes at least one of:
face detection information generated corresponding to detected facial features for the one or more objects; or
torso detection information generated corresponding to detected torso features for the one or more objects.

12. The method of claim 1, wherein the object information includes at least one of:
depth estimation information generated for at least a portion of the plurality of objects;
pose or gaze information generated for at least a portion of the plurality of objects; or movement information determined for at least a portion of the plurality of objects.

13. The method of claim 1, wherein determining the object information includes:
using one or more machine learning networks to determine predicted object information for each respective object of the plurality of objects, wherein the predicted object information is indicative of a classification of the respective object within the subset of one or more objects or within the at least one additional object.

14. The method of claim 13, wherein generating the edited image data includes at least one of:
using the predicted object information to determine the subset of one or more objects included in the edited image data; or
using the predicted object information to determine the at least one additional object to not include in the edited image data.

15. The method of claim 13, further comprising:
outputting for display an edited preview frame indicative of a subset of objects or additional object classification included in the predicted object information for the respective objects of the plurality of objects;
receiving one or more user inputs indicative of one or more changes to the predicted object information; and
generating the edited image data using predicted object information updated based on the one or more changes.

16. An apparatus for processing image data, comprising:
at least one memory; and
at least one processor coupled to the at least one memory, the at least one processor configured to:
output for display a first frame corresponding to first image data of a scene, the first image data representing a plurality of objects;
determine object information indicative of a subset of one or more objects included in the plurality of objects;
obtain second image data of the scene, the second image data including the plurality of objects;
generate edited image data based on the object information and the second image data, wherein the edited image data includes the subset of objects and does not include at least one additional object of the plurality of objects; and
output for display a second frame corresponding to the edited image data, wherein the second frame includes inpainted pixel data to replace respective captured pixel data corresponding to each additional object of the at least one additional object, and wherein the inpainted pixel data is generated based on neighboring captured pixel data adjacent to the respective captured pixel data corresponding to each respective additional object.

17. The apparatus of claim 16, wherein the at least one processor is configured to:
receive a command to capture an image; and
capture the second frame in response to the command to capture the image.

18. The apparatus of claim 16, wherein the at least one processor is configured to:
output for display a third frame, the third frame corresponding to the edited image data and including a masked representation of each respective additional object of the at least one additional object;
receive a command to capture an image; and
capture the second frame in response to the command to capture the image.

19. The apparatus of claim 18, wherein the masked representation comprises a visual overlay included in an edited preview frame, wherein the visual overlay for each respective additional object is based on at least one of an opacity adjustment or a color adjustment to the one or more pixels of image data corresponding to the respective additional object, and wherein the edited preview frame is the third frame.

20. The apparatus of claim 16, wherein:
the second frame includes respective captured pixel data corresponding to each object of the subset of one or more objects; and
the second frame does not include captured pixel data corresponding to the at least one additional object.
